(19) United States
(12) Patent Application Publication
(10) Pub. No.: US 2020/0272170 A1
(43) Pub. Date: Aug. 27, 2020

(54) PATH PROVIDING DEVICE AND COMMUNICATION SYSTEM COMPRISING THE SAME

(71) Applicant: LG Electronics Inc., Seoul (KR)

(72) Inventors: Jinsang LEE, Seoul (KR); Sungmin KIM, Seoul (KR); Jihyun KIM, Seoul (KR); Seunghwan BANG, Seoul (KR)

(21) Appl. No.: 16/785,110

(22) Filed: Feb. 7, 2020

(30) Foreign Application Priority Data
Feb. 22, 2019 (KR) PCT/KR2019/002222

(51) Int. Cl. G05D 1/02; G08G 1/00; H04W 28/02; H04W 28/24; H04W 4/46

(52) U.S. Cl. CPC G05D 1/0285; G05D 1/0223; G05D 1/0287; H04W 4/46; H04W 28/0226; H04W 28/24; G08G 1/22

(57) ABSTRACT

The present disclosure provides a path providing device for providing a path to a vehicle, and a communication system including the same. The path providing device includes a communication unit configured to receive from a server a high-definition map that is divided into a plurality of tiles and a processor configured to generate forward path information based on the high-definition map, the forward path information being configured, based on a destination being set in the vehicle, to guide the vehicle along a path on which the vehicle is most likely to travel up to the destination, wherein the processor is configured to calculate a communication speed of the server by comparing a data reception amount received from the server to a data request amount requested to the server, and to update the forward path information based on the communication speed.

### CROSS-REFERENCE TO RELATED APPLICATION

This application claims priority to International Application No. PCT/KR2019/002222, having an International Filing Date of Feb. 22, 2019. The disclosure of the prior application is considered part of and is incorporated by reference in the disclosure of this application.

### FIELD

The present disclosure relates to a path providing device for providing a path (route) to a vehicle and a communication system having the same.

### BACKGROUND

A vehicle generally refers to means of transporting people or goods by using kinetic energy. Representative examples of vehicles include automobiles and motorcycles.

For safety and convenience of a user who uses the vehicle, various sensors and devices can be provided in the vehicle, and functions of the vehicle can be diversified.

The functions of the vehicle may be divided into a convenience function for promoting driver's convenience, and a safety function for enhancing safety of the driver and/or pedestrians.

The convenience function may have a development motive associated with the driver's convenience, such as providing infotainment (information+entertainment) to the vehicle, supporting a partially autonomous driving function, or helping the driver ensuring a field of vision at night or at a blind spot. For example, the convenience functions may include various functions, such as an active cruise control (ACC), a smart parking assist system (SPAS), a night vision (NV), a head up display (HUD), an around view monitor (AVM), an adaptive headlight system (AHS), and the like.

The safety function may encompass techniques designed to ensure safeties of the driver and/or pedestrians, and may include various functions, such as a lane departure warning system (LDWS), a lane keeping assist system (LKAS), an autonomous emergency braking (AEB), and the like.

For convenience of a user using a vehicle, various types of sensors and electronic devices may be provided in the vehicle. Specifically, development of an Advanced Driver Assistance System (ADAS) is actively undergoing. In addition, an autonomous vehicle is actively under development.

As the development of the advanced driver assistance system (ADAS) progresses, development of a technology for optimizing user's convenience and safety while driving a vehicle is required.

As part of this effort, in order to effectively transmit electronic Horizon (eHorizon) data to autonomous driving systems and infotainment systems, the European Union Original Equipment Manufacturing (EU OEM) Association has established a data specification and transmission method as a standard under the name “Advanced Driver Assistance Systems Interface Specification (ADASIS).”

In addition, eHorizon (software) is becoming an integral part of safety/ECO/convenience of autonomous vehicles in a connected environment.

### SUMMARY

The present disclosure is directed to solving the aforementioned problems and other drawbacks.

One aspect of the present disclosure is to provide a path providing device capable of changing path information in consideration of a communication speed, and a communication system including the same.

Another aspect of the present disclosure is to provide a path providing device capable of distributing vehicles receiving a high-definition map according to complexity of a predetermined area, and a communication system including the same.

The present disclosure provides a path providing device for providing a path (route) to a vehicle, and a communication system including the same.

The communication system may include a server configured to transmit a high-definition map that is divided into a plurality of tiles and a path providing device configured to generate forward path information based on the high-definition map, the forward path information being configured, based on a destination being set in the vehicle, to guide the vehicle along a path on which the vehicle is most likely to travel up to the destination, wherein the path providing device is configured to update the forward path information according to a communication speed between the server and the path providing device at a corresponding one of the plurality of tiles where the vehicle is located.

According to an implementation, the path providing device is configured to update the forward path information such that at least one of the path or a speed of the vehicle is varied according to the communication speed.

According to an implementation, the server is configured to calculate the communication speed and transmit a message to the path providing device based on the communication speed satisfying a preset condition, and wherein the path providing device is configured to update the forward path information based on the message.

According to an implementation, the server is configured to calculate a communication speed for a main tile where the vehicle is located and for each of a plurality of sub tiles that are adjacent to the main tile, and wherein the path providing device is configured to update the forward path information based on at least one sub tile among the plurality of sub tiles that has a communication speed higher than that of the main tile.

According to an implementation, the server is configured to restrict a transmission of the message based on none of the plurality of sub tiles having a communication speed that is faster than that of the main tile.

According to an implementation, the server is configured to calculate a communication speed of any one of the plurality of tiles by using at least one of a data request amount requested by at least one vehicle located in the any one tile or a data transmission amount transmitted to the at least one vehicle.

According to an implementation, the server is configured to divide the tile corresponding to a location of the vehicle into a first portion and a second portion, and wherein the path providing device is configured to update the forward path information to have a first speed based on the vehicle being located in the first portion and a second speed different from the first speed based on the vehicle being located in the second portion.

According to an implementation, the path providing device is configured to calculate the communication speed by comparing a data reception amount from the server to a data request amount to the server.

According to an implementation, the path providing device is configured to request map information from an external device located near the vehicle based on the communication speed being less than a reference value.

According to an implementation, the path providing device is configured to transmit at least part of information received from the server to the external device.

According to an implementation, the path providing device is configured, based on the external device being an additional vehicle and driving information being received from the additional vehicle, to update the forward path information based on the driving information to perform platooning with the additional vehicle.

According to an implementation, the path providing device is configured to transmit the forward path information to the external device. Also, the present disclosure provides a path providing device for providing a path to a vehicle.

The path providing device may include a communication unit configured to receive from a server a high-definition map that is divided into a plurality of tiles and a processor configured to generate forward path information based on the high-definition map, the forward path information being configured, based on a destination being set in the vehicle, to guide the vehicle along a path on which the vehicle is most likely to travel up to the destination, wherein the processor is configured to calculate a communication speed of the server by comparing a data reception amount received from the server to a data request amount requested to the server, and to update the forward path information based on the communication speed.

According to an implementation, the processor is configured to generate a speed adjustment command to thereby vary a speed of the vehicle based on the communication speed being less than a reference value.

According to an implementation, the tile corresponding to a location of the vehicle is divided into a first portion and a second portion, and wherein the processor is configured to generate the speed adjustment command such that the vehicle has a first speed in the first portion and a second speed different from the first speed in the second portion.

According to an implementation, the processor is configured to request at least part of information, which is to be requested to the server, to an external device located near the vehicle based on the communication speed being less than a reference value.

According to an implementation, the processor is configured to control the communication unit to transmit at least part of information received from the server to the external device.

According to an implementation, the processor is configured, based on the external device being an additional vehicle and driving information being received from the additional vehicle, to update the forward path information based on the driving information to perform platooning with the additional vehicle.

According to an implementation, the processor is configured to control the communication unit to transmit the forward path information to the external device.

According to an implementation, a communication speed is calculated for a main tile where the vehicle is located and for each of a plurality of sub tiles that are adjacent to the main tile, and wherein the processor is configured to update the forward path information based on at least one sub tile among the plurality of sub tiles that has a communication speed higher than that of the main tile.

Hereinafter, effects of a path providing device and a communication system having the same according to the present disclosure will be described.

The real-time property of an HD map is essential for autonomous travel of the vehicle 100, and may be secured only when a communication speed is higher than a reference. Since the path providing device and the communication system update forward path information so that the communication speed is maintained to be higher than the reference, the safety of the vehicle 100 can be more enhanced. In other words, an accident or error which occurs due to failed reception of necessary information can be prevented in advance.

### BRIEF DESCRIPTION OF THE DRAWINGS

FIG. 1 is a view illustrating appearance of an example vehicle in accordance with an implementation of the present disclosure.

FIG. 2 is a view illustrating external appearances of an example vehicle at various angles in accordance with an implementation of the present disclosure.

FIGS. 3 and 4 are views illustrating example interiors of a vehicle in accordance with an implementation of the present disclosure.

FIGS. 5 and 6 are reference views illustrating example objects in accordance with an implementation of the present disclosure.

FIG. 7 is a block diagram illustrating an example vehicle in accordance with an implementation of the present disclosure.

FIG. 8 is a conceptual view illustrating an example Electronic Horizon Provider (EHP) in accordance with the present disclosure.

FIG. 9 is a block diagram illustrating an example path providing device of FIG. 8 in more detail.

FIG. 10 is a conceptual view illustrating eHorizon in accordance with the present disclosure.

FIGS. 11A and 11B are conceptual views illustrating a Local Dynamic Map (LDM) and an Advanced Driver Assistance System (ADAS) MAP according to the present disclosure.

FIGS. 12A and 12B are exemplary views illustrating an example method in which a path providing device receives high-definition map data in accordance with an implementation of the present disclosure.

FIG. 13 is a flowchart illustrating an example method in which a path providing device generates forward path information by receiving a high-definition map.

FIG. 14 is a flowchart illustrating an example method in which a path providing device selectively transmits sensing information generated in a vehicle.

FIG. 15 is a flowchart illustrating an example method in which a path providing device selectively transmits sensing information according to priorities.

FIG. 16 is a flowchart illustrating an example method in which a path providing device calculates accuracy of sensing information based on a position of a vehicle calculated by positioning.

FIG. 17 is a flowchart illustrating an example method in which a path providing device does not transmit sensing information to a server based on a transmission restriction message received from the server.

FIG. 18 is a flowchart illustrating an example operation of a communication system including a path providing device and a server.

FIG. 19 is a flowchart illustrating an example operation of a communication system in accordance with the present disclosure.

FIG. 20 is a flowchart illustrating in more detail an example operation of a communication system in consideration of a communication speed of each tile.

FIG. 21 is a conceptual view illustrating an example method of performing different controls by dividing a predetermined tile.

FIG. 22 is a flowchart illustrating an example operation of a path providing device performing platooning based on a communication speed.

### DETAILED DESCRIPTION

Description will now be given in detail according to exemplary implementations disclosed herein, with reference to the accompanying drawings. The accompanying drawings are used to help understand the technical idea of the present disclosure and it should be understood that the idea of the present disclosure is not limited by the accompanying drawings. The idea of the present disclosure should be construed to extend to any alterations, equivalents and substitutes besides the accompanying drawings.

A vehicle according to an implementation of the present disclosure may be understood to include cars, motorcycles and the like. Hereinafter, for ease of illustration, the vehicle will be described based on a car.

The vehicle according to the implementation of the present disclosure may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

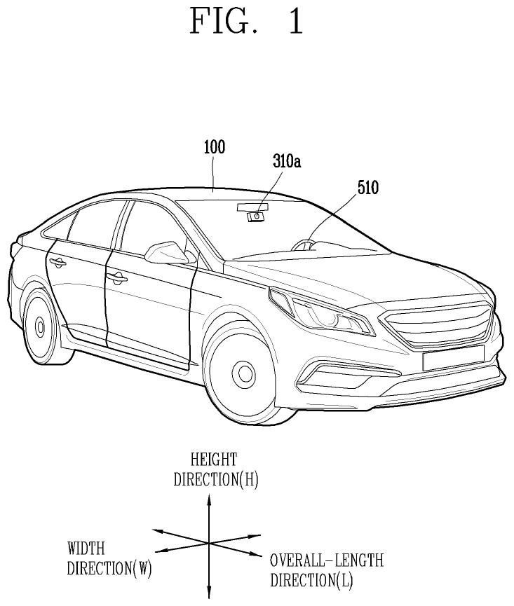

FIG. 1 is a view illustrating appearance of a vehicle in accordance with an implementation of the present disclosure.

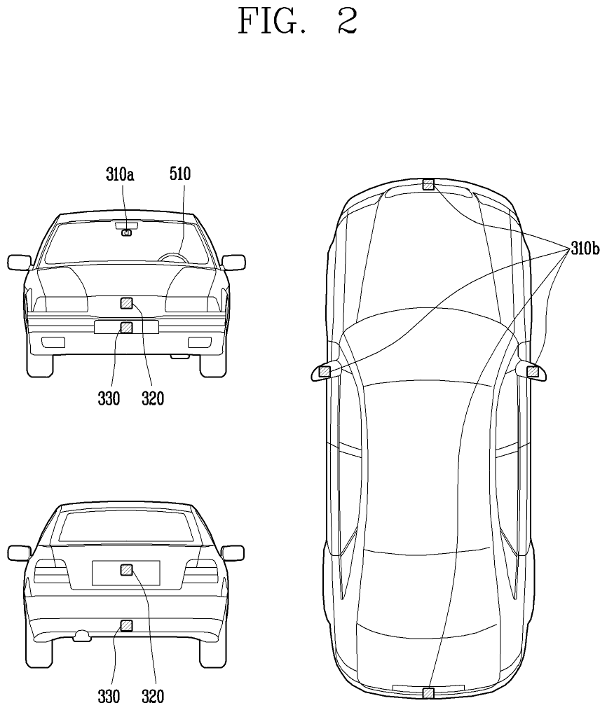

FIG. 2 is a view illustrating appearance of a vehicle at various angles in accordance with an implementation of the present disclosure.

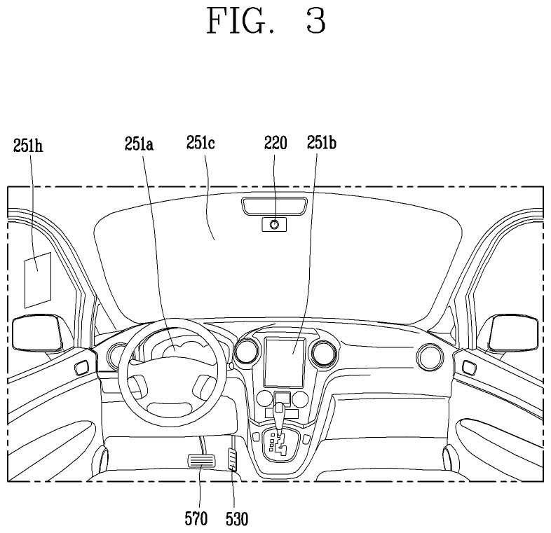

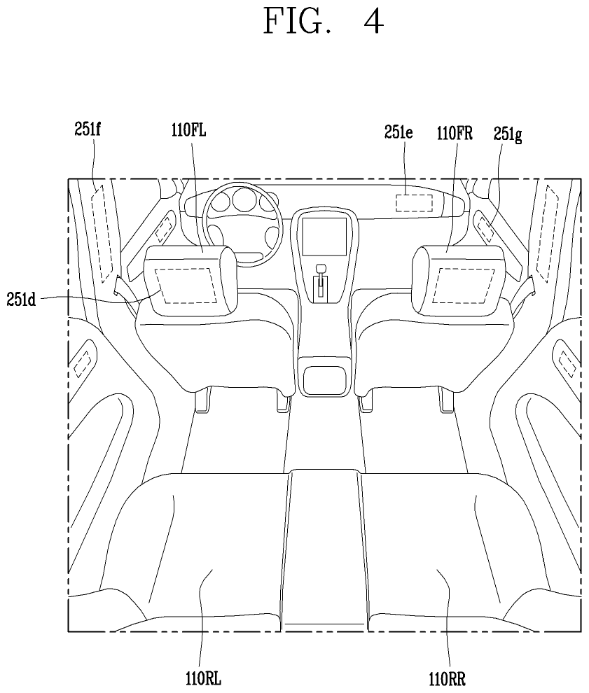

FIGS. 3 and 4 are views illustrating an inside of a vehicle in accordance with an implementation of the present disclosure.

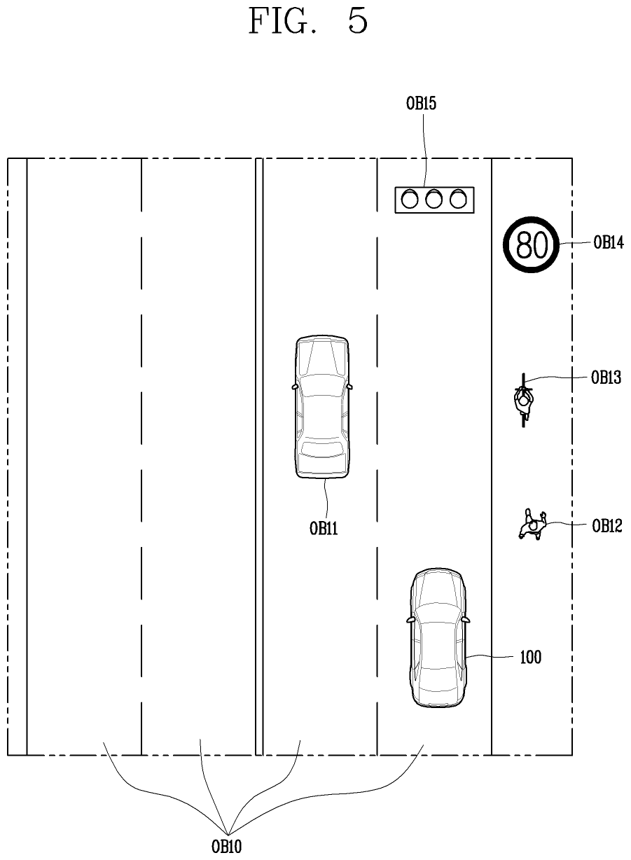

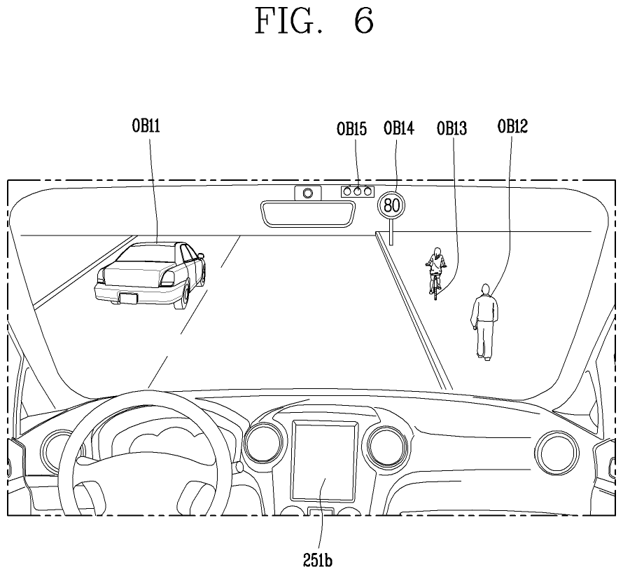

FIGS. 5 and 6 are reference views illustrating objects in accordance with an implementation of the present disclosure.

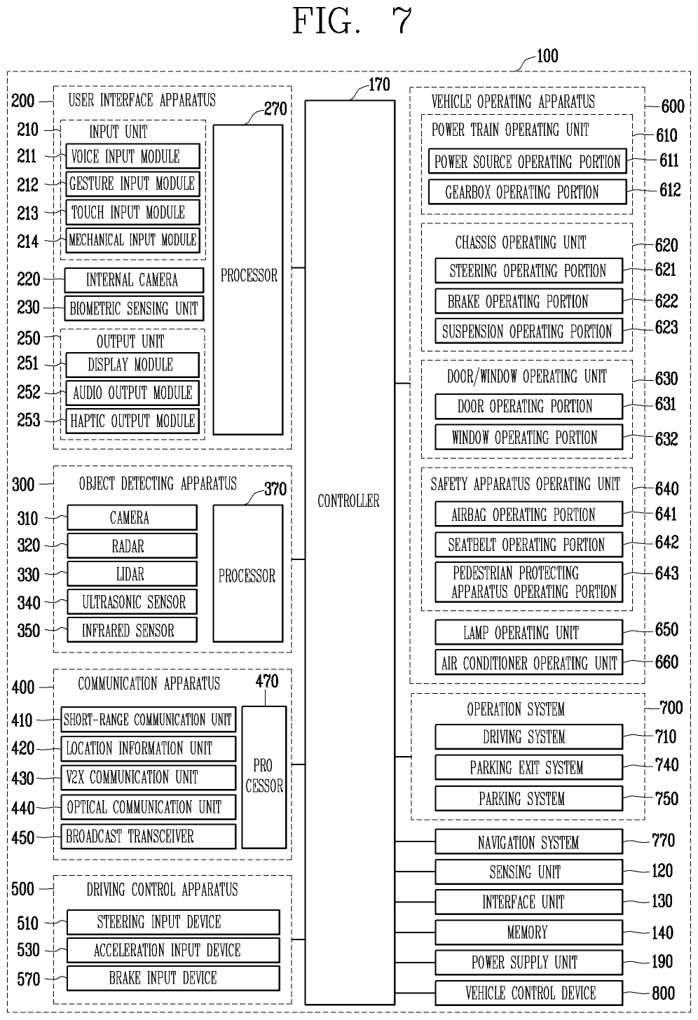

FIG. 7 is a block diagram illustrating a vehicle in accordance with an implementation of the present disclosure.

As illustrated in FIGS. 1 to 7, a vehicle 100 may include wheels that are turned by a driving force, and a steering input device 510 for adjusting a driving (ongoing, moving) direction of the vehicle 100.

The vehicle 100 may be an autonomous vehicle. The vehicle 100 may be switched into an autonomous mode or a manual mode based on a user input. For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700. For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

According to some implementations, the vehicle 100 may include additional components beyond those explained in this specification, or may not include some of those components explained in this specification.

The user interface apparatus 200 is an apparatus for communication between the vehicle 100 and a user. The user interface apparatus 200 may receive a user input and provide information generated in the vehicle 100 to the user. The vehicle 100 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to some implementations, the user interface apparatus 200 may include more components in addition to components to be explained in this specification, or alternatively may not include some of the components explained in this specification.

The input unit 210 may allow the user to input information. Data collected in the input unit 120 may be analyzed by the processor 270 and processed as a user's control command.

The input unit 210 may be disposed inside the vehicle. For example, the input unit 210 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include an audio input module 211, a gesture input module 212, a touch input module 213, and a mechanical input module 214.

The audio input module 211 may convert a user's voice input into an electric signal. The converted electric signal may be provided to the processor 270 or the controller 170.

The audio input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to some implementations, the gesture input module 212 may detect a user's three-dimensional (3D) gesture input. To this end, the gesture input module 212 may include a light-emitting diode outputting a plurality of infrared rays or a plurality of image sensors.

The gesture input module 212 may detect the user's 3D gesture input by a time of flight (TOF) method, a structured light method, or a disparity method, for example.

The touch input module 213 may convert the user's touch input into an electric signal. The converted electric signal may be provided to the processor 270 or the controller 170.

The touch input module 213 may include a touch sensor for detecting the user's touch input.

According to an implementation, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door, and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing unit 230 may include a sensor for detecting the user's biometric information and acquire fingerprint information and heart rate information regarding the user using the sensor. The biometric information may be used for user authentication.

The output unit 250 may generate an output related to a visual, audible, or tactile signal.

The output unit 250 may include at least one of a display module 251, an audio output module 252, and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display, and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

In some implementations, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an implementation, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

In some cases, the user interface apparatus 200 may be referred to as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

For example, referring to FIGS. 5 and 6, an object O may include a traffic lane OB10, another (additional) vehicle OB11, a pedestrian OB12, a two-wheeled vehicle OB13, traffic signals OB14 and OB15, light, a road, a structure, a speed hump, a terrain, an animal, and the like.

The lane OB01 may be a driving lane, a lane next to the driving lane, or a lane on which another vehicle comes in an opposite direction to the vehicle 100. The lanes OB10 may be a concept including left and right lines forming a lane.

The additional vehicle OB11 may be a vehicle which is moving around the vehicle 100. The additional vehicle OB11 may be a vehicle located within a predetermined distance from the vehicle 100. For example, the additional vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or a roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge, and the like.

The terrain may include a mountain, a hill, and the like.

In some cases, objects may be classified into a moving object and a fixed object. For example, the moving object may be a concept including another vehicle and a pedestrian. The fixed object may be a concept including a traffic signal, a road and a structure, for example.

The object detecting apparatus 300 may include a camera 310, a radar 320, a LiDAR 330, an ultrasonic sensor 340, an infrared sensor 350, and/or a processor 370.

According to an implementation, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b, or a 360-degree camera.

For example, the camera 310 may be disposed adjacent to a front windshield within the vehicle to acquire a front image of the vehicle. Alternatively or additionally, the camera 310 may be disposed adjacent to a front bumper or a radiator grill.

For example, the camera 310 may be disposed adjacent to a rear glass within the vehicle to acquire a rear image of the vehicle. Alternatively or additionally, the camera 310 may be disposed adjacent to a rear bumper, a trunk or a tail gate.

For example, the camera 310 may be disposed adjacent to at least one of side windows within the vehicle to acquire a side image of the vehicle. Alternatively or additionally, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift keying (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear, or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object, and a relative speed with the detected object.

The ultrasonic sensor 340 may be disposed on an appropriate position outside the vehicle for detecting an object located at the front, rear, or side of the vehicle.

The infrared sensor 350 may include infrared light transmitting and receiving portions. The infrared sensor 340 may detect an object based on infrared light, and detect a position of the detected object, a distance from the detected object, and a relative speed with the detected object.

The infrared sensor 350 may be disposed on an appropriate position outside the vehicle for detecting an object located at the front, rear, or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an implementation, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an implementation, the communication apparatus 400 may further include other components in addition to the components described, or may not include some of the components described.

The short-range communication unit 410 is a unit for facilitating short-range communications. Suitable technologies for implementing such short-range communications include Bluetooth, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V), and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an implementation, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an implementation, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

In some cases, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 may be configured in the form of a wheel allowing a steering input in a rotating manner. According to some implementations, the steering input device may also be configured in a shape of a touch screen, a touch pad or a button.

The acceleration input device 530 may receive an input for accelerating the vehicle 100 from the user. The brake input device 570 may receive an input for braking the vehicle 100 from the user. Each of the acceleration input device 530 and the brake input device 570 may be configured in the form of a pedal. According to some implementations, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some implementations, the vehicle operating apparatus 600 may further include other components in addition to the components described, or may not include some of the components described.

In some cases, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, if using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may be used to control a gearbox. For example, the gearbox operating portion 612 may adjust a state of the gearbox. The gearbox operating portion 612 may change the state of the gearbox into drive (forward) (D), reverse (R), neutral (N), or park (P).

In some cases, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622, and a suspension operating portion 623.

The steering operating portion 621 may perform an electronic control for a steering input device within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

In some cases, the brake operating portion 622 may individually control each of a plurality of brakes. That is, the brake operating portion 622 may apply a different braking force to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

In some cases, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642, and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to some implementations, the operation system 700 may further include other components in addition to components to be described, or may not include some of the components to be described.

In some cases, the operation system 700 may include a processor. Each unit of the operation system 700 may individually include a processor.

According to some implementations, the operation system may be a sub concept of the controller 170 when it is implemented in a software configuration.

In some cases, according to an implementation, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit process of the vehicle 100 from a parking lot. For example, the parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform a parking process of the vehicle 100. For example, the parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to some implementations, the navigation system 770 may update prestored information by receiving information from an external device through the communication apparatus 400.

According to some implementations, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

In some cases, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 may be electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to some implementations, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

In some cases, the vehicle 100 according to the present disclosure may include a path providing device 800.

The path providing device 800 may control at least one of those components illustrated in FIG. 7. From this perspective, the path providing device 800 may be the controller 170.

In some implementations, the path providing device 800 may be a separate device, independent of the controller 170. When the path providing device 800 is implemented as a component independent of the controller 170, the path providing device 800 may be provided on a part of the vehicle 100.

Hereinafter, description will be given of an example that the path providing device 800 is a component separate from the controller 170 for the sake of explanation. In this specification, functions (operations) and control methods described in relation to the path providing device 800 may be executed by the controller 170 of the vehicle. That is, every detail described in relation to the path providing device 800 may be applied to the controller 170 in the same/like manner.

Also, the path providing device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, description will be given in more detail of a method of autonomously traveling a vehicle related to the present disclosure in an optimized manner or providing path information optimized for the travel of the vehicle, with reference to the accompanying drawings.

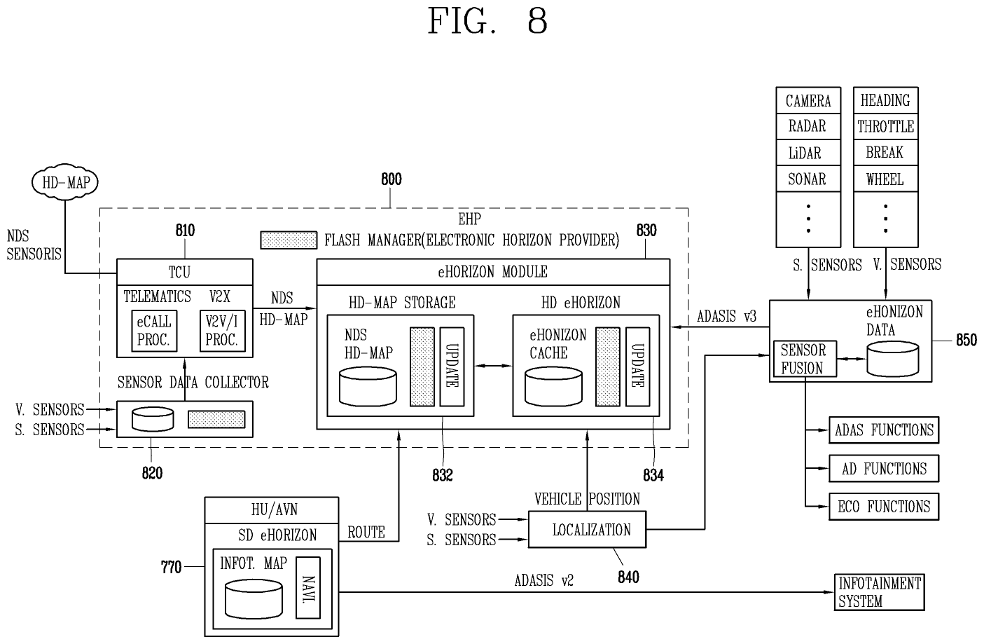

FIG. 8 is a conceptual view illustrating an Electronic Horizon Provider (EHP) in accordance with the present disclosure.

Referring to FIG. 8, the path providing device 800 associated with the present disclosure may autonomously control the vehicle 100 based on eHorizon (electronic Horizon).

The path providing device 800 may be an electronic horizon provider (EHP).

Here, Electronic Horizon may be referred to as “ADAS Horizon,” “ADASIS Horizon”, “Extended Driver Horizon,” or “eHorizon.”

eHorizon may be understood as software, module, or system that plays a role of generating forward path information regarding a vehicle using high-definition (HD) map data, constructing the generated path information to be appropriate for a predetermined protocol (for example, a protocol defined in ADASIS), and transmitting the information to a module (e.g., ECU, the controller 170, the navigation system 770, etc.) of the vehicle, which needs map information (or path information) or an application (e.g., ADAS application, map application, etc.) installed in the vehicle. HD map data may provide, for example, centimeter-level precision.

In the related art, a forward path (or a path up to destination) of a vehicle has been provided as a single path based on a navigation map. However, eHorizon can provide lane-based path information on the basis of an HD map.

Data generated by eHorizon may be referred to as “electronic horizon data” or “eHorizon data.”

The electronic horizon data may be described as driving plan data used when generating a driving control signal of the vehicle 100 in a driving (traveling) system. For example, the electronic horizon data may be understood as driving plan data in a range from a point where the vehicle 100 is located to horizon.

Here, the horizon may be understood as a point in front of the point where the vehicle 100 is located, by a preset distance, on the basis of a preset travel path. The horizon may refer to a point where the vehicle 100 is to reach after a predetermined time from the point, at which the vehicle 100 is currently located, along a preset travel path. Here, the travel path refers to a path for the vehicle to travel up to a final destination, and may be set by a user input.

Electronic horizon data may include horizon map data and horizon path data. The horizon map data may include at least one of topology data, ADAS data, HD map data, and dynamic data. According to an implementation, the horizon map data may include a plurality of layers. For example, the horizon map data may include a first layer that matches topology data, a second layer that matches ADAS data, a third layer that matches HD map data, and a fourth layer that matches dynamic data. The horizon map data may further include static object data.

Topology data may be described as a map created by connecting road centers. Topology data is suitable for roughly indicating the position of a vehicle and may be in the form of data mainly used in a navigation for a driver. Topology data may be understood as data for road information excluding lane-related information. Topology data may be generated based on data received by an infrastructure through V2I. Topology data may be based on data generated in an infrastructure. Topology data may be based on data stored in at least one memory included in the vehicle 100.

ADAS data may refer to data related to road information. ADAS data may include at least one of road slope data, road curvature data, and road speed limit data. ADAS data may further include no-passing zone data. ADAS data may be based on data generated in an infrastructure. ADAS data may be based on data generated by the object detecting apparatus 300. ADAS data may be named road information data.

HD map data may include detailed lane-unit topology information regarding a road, connection information of each lane, and feature information for localization of a vehicle (e.g., traffic signs, lane marking/attributes, road furniture, etc.). HD map data may be based on data generated in an infrastructure.

Dynamic data may include various dynamic information that may be generated on a road. For example, the dynamic data may include construction information, variable-speed lane information, road surface state information, traffic information, moving object information, and the like. Dynamic data may be based on data received by an infrastructure. Dynamic data may be based on data generated by the object detecting apparatus 300.

The path providing device 800 may provide map data within a range from a point where the vehicle 100 is located to the horizon. The horizon path data may be described as a trajectory that the vehicle 100 can take within the range from the point where the vehicle 100 is located to the horizon. The horizon path data may include data indicating a relative probability to select one road at a decision point (e.g., fork, intersection, crossroads, etc.). Relative probability may be calculated based on a time taken to arrive at a final destination. For example, if a shorter time is taken to arrive at the final destination when selecting a first road than when selecting a second road at a decision point, the probability to select the first road may be calculated higher than the probability to select the second road.

The horizon path data may include a main path and a sub path. The main path may be understood as a trajectory connecting roads with a higher relative probability to be selected. The sub path may be branched at at least one decision point on the main path. The sub path may be understood as a trajectory connecting at least one road having a low relative probability to be selected at the at least one decision point on the main path.

eHorizon may be classified into categories such as software, system, concept, and the like. eHorizon denotes a configuration of fusing real-time events, such as road shape information of a high-definition map, real-time traffic signs, road surface conditions, accidents and the like, under a connected environment of an external server (cloud server), V2X (Vehicle to everything) or the like, and providing the fused information to autonomous driving systems and infotainment systems.

In other words, eHorizon may perform the role of transferring a road shape on a high-definition map and real-time events with respect to the front of the vehicle to autonomous driving systems and infotainment systems under an external server/V2X environment.

In order to effectively transfer eHorizon data (information) transmitted from eHorizon (i.e., external server) to autonomous driving system and infotainment system, a data specification (protocol) and transmission method may be defined in accordance with a standard called “Advanced Driver Assistance Systems Interface Specification (ADAS IS).”

The vehicle 100 related to the present disclosure may use information, which is received (generated) in eHorizon, in an autonomous driving system and/or an infotainment system.

For example, the autonomous driving system may use information provided by eHorizon in safety and eco-friendly aspects.

In terms of the safety aspect, the vehicle 100 according to the present disclosure may perform an Advanced Driver Assistance System (ADAS) function such as Lane Keeping Assist (LKA), Traffic Jam Assist (TJA) or the like, and/or an AutoDrive (AD) function such as passing, road joining, lane change or the like, by using road shape information and event information received from eHorizon and surrounding object information sensed through a sensing unit, or localization unit, 840 provided in the vehicle.

Furthermore, in terms of the eco-friendly aspect, the path providing device 800 may receive slope information, traffic light information, and the like related to a forward road from eHorizon, to control the vehicle so as to get efficient engine output, thereby enhancing fuel efficiency.

The infotainment system may include an convenience aspect. For example, the vehicle 100 may receive from eHorizon accident information, road surface condition information, and the like related to a road ahead of the vehicle and output those information on a display unit (for example, Head Up Display (HUD), CID, Cluster, etc.) provided in the vehicle, so as to provide guide information for the driver to drive the vehicle safely.

eHorizon (external server) may receive position information related to various types of event information (e.g., road surface condition information, construction information, accident information, etc.) occurred on roads and/or road-based speed limit information from the vehicle 100 or other vehicles or may collect such information from infrastructures (for example, measuring devices, sensing devices, cameras, etc.) installed on roads.

In addition, the event information and the road-based speed limit information may be linked to map information or may be updated. Additionally, the position information related to the event information may be divided into lane units.

By using such information, the eHorizon system (EHP) of the present disclosure can provide information necessary for the autonomous driving system and the infotainment system to each vehicle, based on a high-definition map on which road conditions (or road information) can be determined on the lane basis.

In other words, an electronic horizon (eHorizon) Provider (EHP) of the present disclosure may provide an absolute high-definition map using absolute coordinates of road-related information (for example, event information, position information regarding the vehicle 100, etc.) based on a high-definition map.

The road-related information provided by the eHorizon may be information included in a predetermined area (predetermined space) with respect to the vehicle 100.

The EHP may be understood as a component which is included in an eHorizon system and performs functions provided by the eHorizon (or eHorizon system).

The path providing device 800 of the present disclosure may be EHP, as shown in FIG. 8.

The path providing device 800 (EHP) of the present disclosure may receive a high-definition map from an external server (or a cloud server), generate path (route) information to a destination in lane units, and transmit the high-definition map and the path information generated in the lane units to a module or application (or program) of the vehicle requiring the map information and the path information.

Referring to FIG. 8, FIG. 8 illustrates an overall structure of an Electronic Horizon (eHorizon) system of the present disclosure.

The path providing device 800 (EHP) of the present disclosure may include a telecommunication control unit (TCU) 810, or communication unit, that receives a high-definition map (HD-map) existing in a cloud server.

The TCU 810 may be the communication device 400 described above, and may include at least one of components included in the communication device 400.

The TCU 810 may include a telematics module or a vehicle to everything (V2X) module.

The TCU 810 may receive an HD map that complies with the Navigation Data Standard (NDS) (or conforms to the NDS standard) from the cloud server.

In addition, the HD map may be updated by reflecting data sensed by sensors provided in the vehicle and/or sensors installed around roads, according to the sensor ingestion interface specification (SENSORIS).

The TCU 810 may download the HD map from the cloud server through the telematics module or the V2X module.

The path providing device 800 (EHP) of the present disclosure may include a sensor data collector 820. The sensor data collector 820, or interface unit, collects (receives) information sensed by sensors (V.Sensors) provided in the vehicle for detecting a manipulation of the vehicle (e.g., heading, throttle, break, wheel, etc.) and sensors (S.Sensors) for detecting surrounding information of the vehicle (e.g., Camera, Radar, LiDAR, Sonar, etc.).

The sensor data collector 820 may transmit the information sensed through the sensors provided in the vehicle to the TCU 810 (or a processor 830) so that the information is reflected in the HD map.

The TCU 810 may update the HD map stored in the cloud server by transmitting the information transmitted from the sensor data collector 820 to the cloud server.

The path providing device 800 (EHP) of the present disclosure may include a processor 830 (or an eHorizon module).

The processor 830 may control the TCU 810 and the sensor data collector 820.

The processor 830 may store the HD map received through the TCU 810, and update the HD map using the information received through the sensor data collector 820. This operation may be performed in the storage part 832 of the processor 830.

The processor 830 may receive first path information from an audio video navigation (AVN) or a navigation system 770.

The first path information is route information provided in the related art and may be information for guiding a traveling path (travel path, driving path, driving route) to a destination.

In this case, the first path information provided in the related art may provide only one path information without distinguishing individual lanes.

In contrast, when the processor 830 receives the first path information, the processor 830 may generate second path information for guiding, in lane units, a traveling path up to the destination set in the first path information, by using the HD map and the first path information. For example, the operation may be performed by a calculating part 834 of the processor 830.

In addition, the eHorizon system may include a localization unit 840 for identifying the position of the vehicle by using information sensed through the sensors (V.Sensors, S.Sensors) provided in the vehicle.

The localization unit 840 may transmit the position information of the vehicle to the processor 830 to match the position of the vehicle identified by using the sensors provided in the vehicle with the HD map.

The processor 830 may match the position of the vehicle 100 with the HD map based on the position information of the vehicle.

The processor 830 may generate electronic horizon (eHorizon) data. The processor 830 may generate horizon map data. The processor 830 may generate horizon path data.

The processor 830 may generate electronic horizon data by reflecting the traveling situation of the vehicle 100. For example, the processor 830 may generate electronic horizon data based on traveling direction data and traveling speed data of the vehicle 100.

The processor 830 may merge the generated electronic horizon data with previously-generated electronic horizon data. For example, the processor 830 may connect horizon map data generated at a first time point with horizon map data generated at a second time point on the position basis. For example, the processor 830 may connect horizon path data generated at a first time point with horizon path data generated at a second time point on the position basis.

The processor 830 may include a memory, an HD map processing part, a dynamic data processing part, a matching part, and a path generating part.

The HD map processing part may receive HD map data from a server through the TCU. The HD map processing part may store the HD map data. According to an implementation, the HD map processing part may also process the HD map data. The dynamic data processing part may receive dynamic data from the object detecting apparatus. The dynamic data processing part may receive the dynamic data from a server. The dynamic data processing part may store the dynamic data. In some implementations, the dynamic data processing part may process the dynamic data.

The matching part may receive an HD map from the HD map processing part. The matching part may receive dynamic data from the dynamic data processing part. The matching part may generate horizon map data by matching the HD map data with the dynamic data.

According to an implementation, the matching part may receive topology data. The matching part may receive ADAS data. The matching part may generate horizon map data by matching the topology data, the ADAS data, the HD map data, and the dynamic data. The path generating part may generate horizon path data. The path generating part may include a main path generator and a sub path generator. The main path generator may generate main path data. The sub path generator may generate sub path data.

In addition, the eHorizon system may include a fusion unit 850 for fusing information (data) sensed through the sensors provided in the vehicle and eHorizon data generated by the eHorizon module (control unit).

For example, the fusion unit 850 may update an HD map by fusing sensing data sensed by the vehicle with an HD map corresponding to eHorizon data, and provide the updated HD map to an ADAS function, an AD (AutoDrive) function, or an ECO function.

In addition, the fusion unit 850 may provide the updated HD map to the infotainment system.

FIG. 8 illustrates that the path providing device 800 (EHP) of the present disclosure merely includes the TCU 810, the sensor data collector 820, and the processor 830, but the present disclosure is not limited thereto.

The path providing device 800 (EHP) of the present disclosure may further include at least one of the localization unit 840 and the fusion unit 850.

In addition, the path providing device 800 (EHP) of the present disclosure may further include a navigation system 770.

With such a configuration, when at least one of the localization unit 840, the fusion unit 850, and the navigation system 770 is included in the path providing device 800 (EHP) of the present disclosure, the functions/operations/controls performed by the included configuration may be understood as being performed by the processor 830.

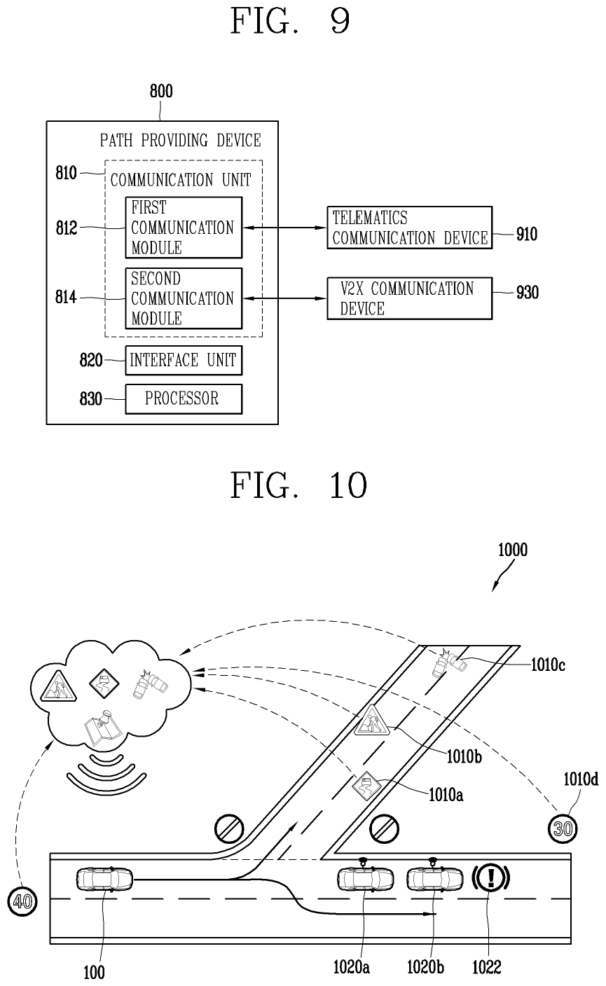

FIG. 9 is a block diagram illustrating the path providing device of FIG. 8 in more detail.

The path providing device refers to a device for providing a route (or path) to a vehicle.

For example, the path providing device may be a device mounted on a vehicle to perform communication through CAN communication and generate messages for controlling the vehicle and/or electric components mounted on the vehicle.

As another example, the path providing device may be located outside the vehicle, like a server or a communication device, and may perform communication with the vehicle through a mobile communication network. In this case, the path providing device may remotely control the vehicle and/or the electric components mounted on the vehicle using the mobile communication network.

The path providing device 800 is provided in the vehicle, and may be implemented as an independent device detachable from the vehicle or may be integrally installed on the vehicle to construct a part of the vehicle 100.

Referring to FIG. 9, the path providing device 800 includes a communication unit 810, an interface unit 820, and a processor 830.

The communication unit 810 is configured to perform communications with various components provided in the vehicle.

For example, the communication unit 810 may receive various information provided through a controller area network (CAN).

The communication unit 810 may include a first communication module 812, and the first communication module 812 may receive an HD map provided through telematics. In other words, the first communication module 812 is configured to perform “telematics communication.” The first communication module 812 performing the telematics communication may perform communication with a server and the like by using a satellite navigation system or a base station provided by mobile communication such as 4G or 5G.

The first communication module 812 may perform communication with a telematics communication device 910. The telematics communication device may include a server provided by a portal provider, a vehicle provider and/or a mobile communication company.

The processor 830 of the path providing device 800 may determine absolute coordinates of road-related information (event information) based on ADAS MAP received from an external server (eHorizon) through the first communication module 812. In addition, the processor 830 may autonomously drive the vehicle or perform a vehicle control using the absolute coordinates of the road-related information (event information).

The communication unit 810 may include a second communication module 814, and the second communication module 814 may receive various types of information provided through vehicle to everything (V2X) communication. In other words, the second communication module 814 is configured to perform “V2X communication.” The V2X communication may be defined as a technology of exchanging or sharing information, such as traffic condition and the like, while communicating with road infrastructures and other vehicles during driving.

The second communication module 814 may perform communication with a V2X communication device 930. The V2X communication device may include a mobile terminal belonging to a pedestrian or a person riding a bike, a fixed terminal installed on a road, another vehicle, and the like.

Here, the another vehicle may denote at least one of vehicles existing within a predetermined distance from the vehicle 100 or vehicles approaching by a predetermined distance or shorter with respect to the vehicle 100.

The present disclosure may not be limited thereto, and the another vehicle may include all the vehicles capable of performing communication with the communication unit 810. According to this specification, for the sake of explanation, an example will be described in which the another vehicle is at least one vehicle existing within a predetermined distance from the vehicle 100 or at least one vehicle approaching by a predetermined distance or shorter with respect to the vehicle 100.

The predetermined distance may be determined based on a distance capable of performing communication through the communication unit 810, determined according to a specification of a product, or determined/varied based on a user's setting or V2X communication standard.

The second communication unit 814 may be configured to receive LDM data from another vehicle. The LDM data may be a V2X message (BSM, CAM, DENM, etc.) transmitted and received between vehicles through V2X communication.

The LDM data may include position information related to the another vehicle.

The processor 830 may determine a position of the vehicle of the present disclosure relative to the another vehicle, based on the position information related to the vehicle 100 and the position information related to the another vehicle included in the LDM data received through the second communication module 814.

In addition, the LDM data may include speed information regarding another vehicle. The processor 830 may also determine a relative speed of the another vehicle using speed information of the vehicle of the present disclosure and the speed information of the another vehicle. The speed information of the vehicle may be calculated using a degree to which the position information of the vehicle received through the communication unit 810 changes over time or calculated based on information received from the driving operation device 500 or the power train driving unit 610 of the vehicle 100.

The second communication module 814 may be the V2X communication unit 430 described above.

If the communication unit 810 is a component that performs communication with a device located outside the vehicle 100 using wireless communication, the interface unit 820 is a component performing communication with a device located inside the vehicle 100 using wired or wireless communication.

The interface unit 820 may receive information related to driving of the vehicle from most of electric components provided in the vehicle 100. Information transmitted from the electric component provided in the vehicle to the path providing device 800 is referred to as “vehicle driving information (or vehicle travel information).”

For example, when the electric component is a sensor, the vehicle driving information may be sensing information sensed by the sensor.

Vehicle driving information includes vehicle information and surrounding information related to the vehicle. Information related to the inside of the vehicle with respect to a frame of the vehicle may be defined as the vehicle information, and information related to the outside of the vehicle may be defined as the surrounding information.

The vehicle information refers to information related to the vehicle itself. For example, the vehicle information may include a traveling speed, a traveling direction, an acceleration, an angular velocity, a location (GPS), a weight, a number of passengers on board the vehicle, a braking force of the vehicle, a maximum braking force, air pressure of each wheel, a centrifugal force applied to the vehicle, a travel mode of the vehicle (autonomous travel mode or manual travel mode), a parking mode of the vehicle (autonomous parking mode, automatic parking mode, manual parking mode), whether or not a user is on board the vehicle, and information associated with the user.

The surrounding information refers to information related to another object located within a predetermined range around the vehicle, and information related to the outside of the vehicle. The surrounding information of the vehicle may be a state of a road surface on which the vehicle is traveling (e.g., a frictional force), the weather, a distance from a preceding (succeeding) vehicle, a relative speed of a preceding (succeeding) vehicle, a curvature of a curve when a driving lane is the curve, information associated with an object existing in a reference region (predetermined region) based on the vehicle, whether or not an object enters (or leaves) the predetermined region, whether or not the user exists near the vehicle, information associated with the user (for example, whether or not the user is an authenticated user), and the like.

The surrounding information may also include ambient brightness, temperature, a position of the sun, information related to a nearby subject (a person, another vehicle, a sign, etc.), a type of a driving road surface, a landmark, line information, and driving lane information, and information required for an autonomous travel/autonomous parking/automatic parking/manual parking mode.

In addition, the surrounding information may further include a distance from an object existing around the vehicle to the vehicle, collision possibility, a type of an object, a parking space for the vehicle, an object for identifying the parking space (for example, a parking line, a string, another vehicle, a wall, etc.), and the like.

The vehicle driving information is not limited to the example described above and may include all information generated from the components provided in the vehicle.

In some cases, the processor 830 is configured to control one or electric components provided in the vehicle using the interface unit 820.

Specifically, the processor 830 may determine whether or not at least one of a plurality of preset conditions is satisfied, based on vehicle travel information received through the communication unit 810. According to a satisfied condition, the processor 830 may control the one or more electric components in different ways.

In connection with the preset conditions, the processor 830 may detect an occurrence of an event in an electric component provided in the vehicle and/or application, and determine whether the detected event meets a preset condition. At this time, the processor 830 may also detect the occurrence of the event from information received through the communication unit 810.

The application may include a widget, a home launcher, and the like, and may refer to all types of programs that can be run on the vehicle. Accordingly, the application may be a program that performs a function of a web browser, a video playback, a message transmission/reception, a schedule management, or an application update.

Further, the application may include at least one of forward collision warning (FCW), blind spot detection (BSD), lane departure warning (LDW), pedestrian detection (PD), Curve Speed Warning (CSW), and turn-by-turn navigation (TBT).

For example, the occurrence of the event may be a missed call, presence of an application to be updated, a message arrival, start on, start off, autonomous travel on/off, pressing of an LCD awake key, an alarm, an incoming call, a missed notification, and the like.

As another example, the occurrence of the event may be a generation of an alert set in the advanced driver assistance system (ADAS), or an execution of a function set in the ADAS. For example, the occurrence of the event may be an occurrence of forward collision warning, an occurrence of blind spot detection, an occurrence of lane departure warning, an occurrence of lane keeping assist warning, or an execution of autonomous emergency braking.

As another example, the occurrence of the event may also be a change from a forward gear to a reverse gear, an occurrence of an acceleration greater than a predetermined value, an occurrence of a deceleration greater than a predetermined value, a change of a power device from an internal combustion engine to a motor, or a change from the motor to the internal combustion engine.

In addition, even when various electronic control units (ECUs) provided in the vehicle perform specific functions, it may be determined as the occurrence of the events.

For example, when a generated event satisfies the preset condition, the processor 830 may control the interface unit 820 to display information corresponding to the satisfied condition on one or more displays provided in the vehicle.

FIG. 10 is a conceptual view illustrating eHorizon in accordance with the present disclosure.

Referring to FIG. 10, the path providing device 800 according to the present disclosure may autonomously drive the vehicle 100 on the basis of eHorizon.

eHorizon may be classified into categories such as software, system, concept, and the like. eHorizon denotes a configuration of fusing real-time events, such as road shape information of a high-definition map, real-time traffic signs, road surface conditions, accidents and the like, under a connected environment of an external server (cloud server), V2X (Vehicle to everything) or the like, and providing the fused information to the autonomous driving system and the infotainment system. In some cases, eHorizon may refer to an external server such as a cloud or a cloud server.

In other words, eHorizon may perform the role of transferring a road shape on a high-definition map and real-time events with respect to the front of the vehicle to the autonomous driving system and the infotainment system under an external server/V2X environment.

In order to effectively transfer eHorizon data (information) transmitted from eHorizon (i.e., external server) to the autonomous driving system and the infotainment system, a data specification and transmission method may be formed in accordance with a standard called “Advanced Driver Assistance Systems Interface Specification (ADAS IS).”

The path providing device 800 related to the present disclosure may use information, which is received from eHorizon, in the autonomous driving system and/or the infotainment system.

For example, the autonomous driving system may be divided into a safety aspect and an eco-friendly aspect.

In terms of the safety aspect, the vehicle 100 according to the present disclosure may perform an Advanced Driver Assistance System (ADAS) function such as Lane Keeping Assist (LKA), Traffic Jam Assist (TJA) or the like, and/or an AD (AutoDrive) function such as passing, road joining, lane change or the like, by using road shape information and event information received from eHorizon and surrounding object information sensed through the sensing unit 840 provided in the vehicle.

Furthermore, in terms of the eco-friendly aspect, the path providing device 800 may receive slope information, traffic light information, and the like related to a forward road from eHorizon, to control the vehicle so as to get efficient engine output, thereby enhancing fuel efficiency.

The infotainment system may include various convenience aspects. For example, the vehicle 100 may receive from eHorizon accident information, road surface condition information, and the like related to a road ahead of the vehicle and output them on a display unit (for example, Head Up Display (HUD), CID, Cluster, etc.) provided in the vehicle, so as to provide guide information for the driver to drive the vehicle safely.

Referring to FIG. 10, the eHorizon (external server) may receive position information related to various types of event information (e.g., road surface condition information 1010a, construction information 1010b, accident information 1010c, etc.) occurred on roads and/or road-based speed limit information 1010d from the vehicle 100 or other vehicles 1020a and 1020b or may collect such information from infrastructures (for example, measuring devices, sensing devices, cameras, etc.) installed on the roads.

In addition, the event information and the road-based speed limit information may be linked to map information or may be updated.

In addition, the position information related to the event information may be divided into lane units.

By using such information, the eHorizon (external server) of the present disclosure can provide information necessary for the autonomous driving system and the infotainment system to each vehicle, based on a high-definition map on which road conditions (or road information) can be determined on the lane basis.

In other words, the eHorizon (external server) may provide an absolute high-definition map using absolute coordinates of road-related information (for example, event information, position information regarding the vehicle 100, etc.) based on a high-definition map.

The road-related information provided by the eHorizon may be information corresponding to a predetermined region (predetermined space) with respect to the vehicle 100.

On the other hand, the path providing device of the present disclosure may acquire position information related to another vehicle through communication with the another vehicle. Communication with the another vehicle may be performed through V2X (Vehicle to everything) communication, and data transmitted/received to/from the another vehicle through the V2X communication may be data in a format defined by a Local Dynamic Map (LDM) standard.

The LDM denotes a conceptual data storage located in a path providing device (or ITS station) including information associated with a safe and normal operation of an application (or application program) provided in a vehicle (or ITS (Intelligent Transport System)). The LDM may, for example, comply with EN standards.

The LDM differs from the foregoing ADAS MAP in the data format and transmission method. For example, the ADAS MAP may correspond to a high-definition map having absolute coordinates received from eHorizon (external server), and the LDM may denote a high-definition map having relative coordinates based on data transmitted and received through V2X communication.

The LDM data (or LDM information) denotes data mutually transmitted and received through V2X communication (vehicle to everything) (for example, V2V (Vehicle to Vehicle) communication, V2I (Vehicle to Infra) communication, or V2P (Vehicle to Pedestrian) communication).

The LDM is a concept of a storage for storing data transmitted and received through V2X communication, and the LDM may be formed (stored) in a path providing device provided in each vehicle.

The LDM data may denote data mutually transmitted and received between vehicles (infrastructures, pedestrians) or the like, for example. The LDM data may include a Basic Safety Message (BSM), a Cooperative Awareness Message (CAM), and a Decentralized Environmental Notification message (DENM), and the like, for example.

The LDM data may be referred to as a V2X message or an LDM message, for example.

The path providing device associated with the present disclosure may efficiently manage LDM data (or V2X messages) transmitted and received between vehicles using the LDM.

Based on LDM data received via V2X communication, the LDM may store, distribute to another vehicle, and continuously update all relevant information (for example, a location of the vehicle according to the present disclosure (or another vehicle), a speed, a traffic light status, weather information, a road surface condition, and the like), related to a traffic situation around a place where the vehicle is currently located (or a road situation for an area within a predetermined distance from the place where the vehicle is currently located).

For example, a V2X application provided in the path providing device 800 registers in the LDM, and receives a specific message such as all the DENMs in addition to a warning about a failed vehicle. Then, the LDM may automatically assign the received information to the V2X application, and the V2X application may control the vehicle based on the information assigned from the LDM.

As described above, the vehicle of the present disclosure may control the vehicle using the LDM formed by the LDM data collected through V2X communication.

The LDM associated with the present disclosure may provide road-related information to the path providing device. The road-related information provided by the LDM provides only a relative distance and a relative speed with respect to another vehicle (or an event generation point), other than map information having absolute coordinates.

In other words, the vehicle of the present disclosure may perform autonomous driving using an ADAS MAP (absolute coordinates HD map) according to the ADASIS standard provided by eHorizon, but the map may be used only to determine a road condition in a surrounding area of the vehicle.

In addition, the vehicle of the present disclosure may perform autonomous driving using an LDM (relative coordinates HD map) formed by LDM data received through V2X communication, but there is a limitation in that accuracy is inferior due to insufficient absolute position information.

The path providing device included in the vehicle of the present disclosure may generate a fused definition map using the ADAS MAP received from the eHorizon and the LDM data received through the V2X communication, and control (autonomously drive) the vehicle in an optimized manner using the fused definition map.

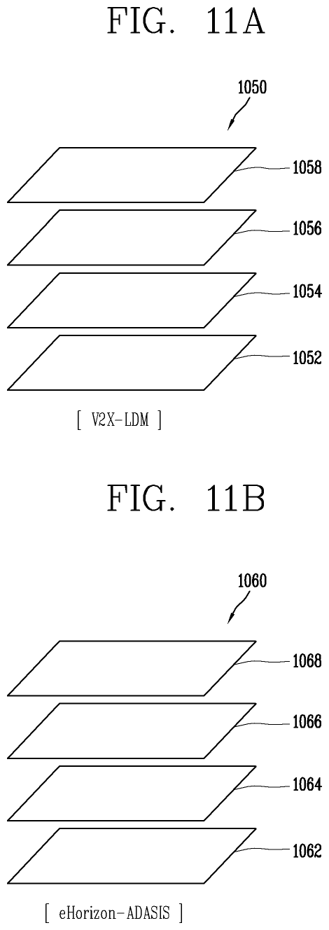

FIG. 11A illustrates an example of a data format of LDM data (or LDM) transmitted and received between vehicles via V2X communication, and FIG. 11B illustrates an example of a data format of an ADAS MAP received from an external server (eHorizon).

Referring to FIG. 11A, the LDM data (or LDM) 1050 may be formed to have four layers.

The LDM data 1050 may include a first layer 1052, a second layer 1054, a third layer 1056 and a fourth layer 1058.

The first layer 1052 may be called Type-1. The first layer 1052 may include, as permanent static data, static information, for example, map information, among the road-related information.

The second layer 1054 may be called Type-2. The second layer 1054 may include, as transient static data, landmark information (for example, specific place information specified by a manufacturer among a plurality of place information included in the map information) among the road-related information. The landmark information may include position information, name information, size information, and the like. Further, the second layer 1054 may include road furniture, such as a guardrail or a sign face, located on a road.

The third layer 1056 may be called Type-3. The third layer 1056 may include, as transient dynamic data, traffic situation related information (for example, traffic light information, construction information, accident information, etc.) among the road-related information. The construction information and the accident information may include position information. For example, construction zone information, lane information under construction, a variable speed lane, a road surface condition, traffic, and the weather may be included in the third layer 1056.

The fourth layer 1058 may be called Type-4. The fourth layer 1058 may include, as highly dynamic data, dynamic information (for example, object information, pedestrian information, other vehicle information, etc.) among the road-related information. The object information, pedestrian information, and other vehicle information may include position information. In other words, the fourth layer 1068 may include information related to a moving object, for example, pedestrian information, other vehicle information, bicycle information, and the like.

In other words, the LDM data 1050 may include information sensed through sensing units of other vehicles or information sensed through a sensing unit of the vehicle of the present disclosure, and may include road-related information that changes in real time as it goes from the first layer to the fourth layer.

Referring to FIG. 11B, the ADAS MAP may be formed to have four layers similar to the LDM data.

The ADAS MAP 1060 may denote data received from eHorizon and formed to conform to the ADASIS specification.

The ADAS MAP 1060 may include a first layer 1062 to a fourth layer 1068.

The first layer 1062 may be called a topology layer or Layer-1.

The first layer 1062 may include topology information. The topology information, for example, is information that explicitly defines a spatial relationship, and may indicate map information. The first layer 1062 is formed to be suitable for roughly displaying the location of the vehicle on a map made by connecting road centerlines.

The second layer 1064 may be called an ADAS layer or Layer-2.

The second layer 1064 may include landmark information (for example, specific place information specified by a manufacturer among a plurality of place information included in the map information) among road-related information. The landmark information may include position information, name information, size information, and the like. The landmark information may include traffic sign information indicating a speed limit, no-passing, a slope, a curvature of a road, and the like. The vehicle and/or the electric component provided in the vehicle may display infotainment information using information included in the second layer 1064, or execute engine power control, headlamp left/right angle adjustment, speed limit cruise control, and the like.

The third layer 1066 may be called a high-definition (HD) map & localization layer or Layer-3.

The third layer 1066 may include detailed lane-unit topology information regarding a road, connection information of each lane, and features for localization of the vehicle. Further, the third layer 1066 includes properties (attributes) of lanes, such as color, shape, type and the like, in the lane unit, and may include road furniture, such as a guardrail or a sign face, located on a road.

The fourth layer 1068 may be called a dynamic layer or Layer-4.

The fourth layer 1068 may include various dynamic information that may occur on a road. For example, construction zone information, lane information under construction, a variable speed lane, a road surface condition, traffic, and the weather may be included as the dynamic information.

In other words, the ADAS MAP 1060 may include road-related information that is transformed in real time as it goes from the first layer to the fourth layer, similarly to the LDM data 1050.

The processor 830 may autonomously drive the vehicle 100.

For example, the processor 830 may autonomously drive the vehicle 100 based on vehicle driving information sensed through various electric components provided in the vehicle 100 and information received through the communication unit 810.

Specifically, the processor 830 may control the communication unit 810 to acquire the position information of the vehicle. For example, the processor 830 may acquire the position information (location coordinates) of the vehicle 100 through the location information unit 420 of the communication unit 810.

Furthermore, the processor 830 may control the first communication module 812 of the communication unit 810 to receive map information from an external server. Here, the first communication module 812 may receive ADAS MAP from the external server (eHorizon). The map information may be included in the ADAS MAP.

In addition, the processor 830 may control the second communication module 814 of the communication unit 810 to receive position information of another vehicle from the another vehicle. Here, the second communication module 814 may receive LDM data from the another vehicle. The position information of the another vehicle may be included in the LDM data.

The another vehicle denotes a vehicle existing within a predetermined distance from the vehicle, and the predetermined distance may be a communication-available distance of the communication unit 810 or a distance set by a user.

The processor 830 may control the communication unit to receive the map information from the external server and the position information of the another vehicle from the another vehicle.

Furthermore, the processor 830 may fuse the acquired position information of the vehicle and the received position information of the another vehicle into the received map information, and control the vehicle 100 based on at least one of the fused map information and vehicle-related information sensed through the sensing unit 840.

Here, the map information received from the external server may denote HD map information (HD-MAP) included in the ADAS MAP. The HD map information may be recorded with road-related information in the lane unit.

The processor 830 may fuse the position information of the vehicle 100 and the position information of the another vehicle into the map information in the lane unit. In addition, the processor 830 may fuse the road-related information received from the external server and the road-related information received from the another vehicle into the map information in the lane unit.

The processor 830 may generate ADAS MAP required for the control of the vehicle using the ADAS MAP received from the external server and the vehicle-related information received through the sensing unit 840.

Specifically, the processor 830 may apply the vehicle-related information sensed within a predetermined range through the sensing unit 840 to the map information received from the external server.

Here, the predetermined range may be an available distance which can be sensed by an electric component provided in the vehicle 100 or may be a distance set by a user.

The processor 830 may control the vehicle by applying the vehicle-related information sensed within the predetermined range through the sensing unit to the map information and then additionally fusing the position information of the another vehicle thereto.

In other words, when the vehicle-related information sensed within the predetermined range through the sensing unit is applied to the map information, the processor 830 may use only the information within the predetermined range from the vehicle, and thus a range capable of controlling the vehicle may be local.

However, the position information of the another vehicle received through the V2X module may be received from the another vehicle existing in a space out of the predetermined range. It may be because the communication-available distance of the V2X module communicating with the another vehicle through the V2X module is farther than the predetermined range of the sensing unit 840.

As a result, the processor 830 may fuse the position information of the another vehicle included in the LDM data received through the second communication module 814 into the map information on which the vehicle-related information has been sensed, so as to acquire the position information of the another vehicle existing in a broader range and more effectively control the vehicle using the acquired information.

For example, it is assumed that a plurality of other vehicles is crowded ahead in a lane in which the vehicle of the present disclosure exists, and it is also assumed that the sensing unit can sense only location (position) information related to an immediately preceding vehicle.

In this case, when only vehicle-related information sensed within a predetermined range on map information is used, the processor 830 may generate a control command for controlling the vehicle such that the vehicle overtakes the preceding vehicle.

However, a plurality of other vehicles may actually exist ahead, which may make the vehicle difficult to overtake other vehicles.

At this time, the present disclosure may acquire location information related to another vehicle received through the V2X module. At this time, the received location information related to the another vehicle may include location information related to not only a preceding vehicle of the vehicle 100 but also a plurality of other vehicles ahead of the preceding vehicle.

The processor 830 may additionally fuse the location information related to the plurality of other vehicles acquired through the V2X module into map information to which the vehicle-related information is applied, so as to determine a situation where it is inappropriate to overtake the preceding vehicle.

With such configuration, the present disclosure can overcome a previous limitation whereby only vehicle-related information acquired through the sensing unit 840 is merely fused to high-definition map information and thus autonomous driving is enabled only within a predetermined range. In other words, the present disclosure can achieve more accurate and stable vehicle control by additionally fusing information related to other vehicles (e.g., speeds, locations of other vehicles), which have been received from the other vehicles located at a farther distance than the predetermined range through the V2X module, as well as vehicle-related information sensed through the sensing unit, into map information.

Vehicle control described herein may include at least one of autonomously driving the vehicle 100 and outputting a warning message associated with the driving of the vehicle.

Hereinafter, description will be given in more detail of a method in which a processor controls a vehicle using LDM data received through a V2X module, ADAS MAP received from an external server (eHorizon), and vehicle-related information sensed through a sensing unit provided in the vehicle, with reference to the accompanying drawings.

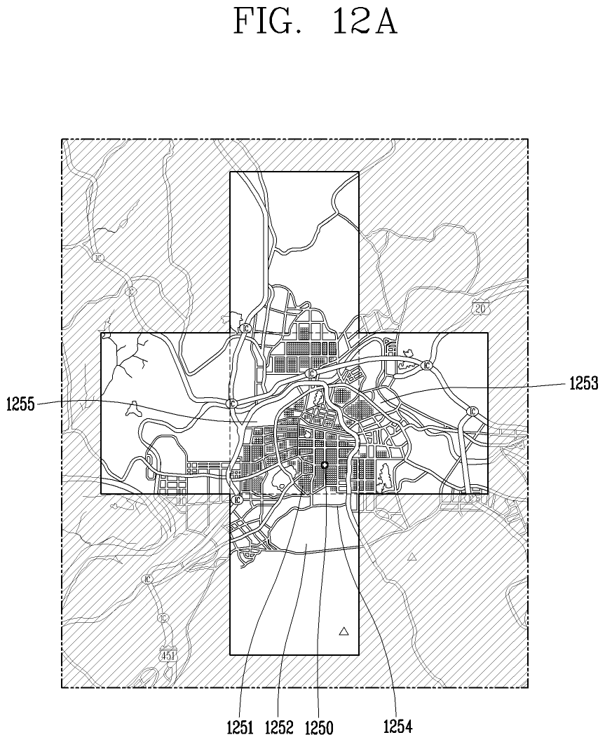

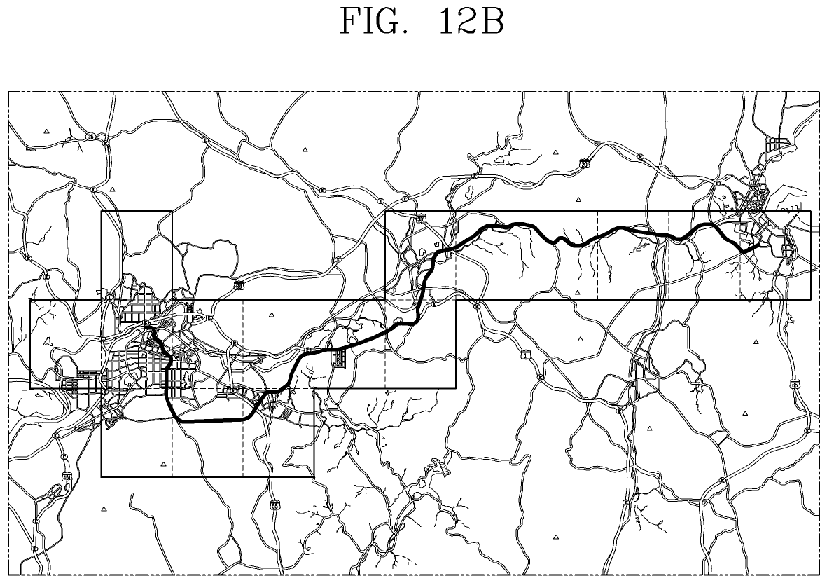

FIGS. 12A and 12B are exemplary views illustrating a method in which a communication device receives high-definition map data in accordance with an implementation of the present disclosure.

The server may divide HD map data into tile units and provide them to the path providing device 800. The processor 830 may receive HD map data in the tile units from the server or another vehicle through the communication unit 810. Hereinafter, HD map data received in tile units is referred to as “HD map tile.”

The HD map data is divided into tiles having a predetermined shape, and each tile corresponds to a different portion of the map. When connecting all the tiles, the full HD map data is acquired. Since the HD map data has a high capacity, the vehicle 100 should be provided with a high-capacity memory in order to download and use the full HD map data. As communication technologies are developed, it may be more efficient to download, use, and delete HD map data in tile units, rather than to provide the high-capacity memory in the vehicle 100.

In the present disclosure, for the convenience of description, a case in which the predetermined shape is rectangular is described as an example, but the predetermined shape may be modified to various polygonal shapes.

The processor 830 may store the downloaded HD map tile in the memory 140. The processor 830 may delete the stored HD map tile. For example, the processor 830 may delete the HD map tile when the vehicle 100 leaves an area corresponding to the HD map tile. For example, the processor 830 may delete the HD map tile when a preset time elapses after storage.

As illustrated in FIG. 12A, when there is no preset destination, the processor 830 may receive a first HD map tile 1251 including a location (position) 1250 of the vehicle 100. The server receives data of the location 1250 of the vehicle 100 from the vehicle 100, and transmits the first HD map tile 1251 including the location 1250 of the vehicle 100 to the vehicle 100. In addition, the processor 830 may receive HD map tiles 1252, 1253, 1254, and 1255 around the first HD map tile 1251. For example, the processor 830 may receive the HD map tiles 1252, 1253, 1254, and 1255 that are adjacent to top, bottom, left, and right sides of the first HD map tile 1251, respectively. In this case, the processor 830 may receive a total of five HD map tiles. For example, the processor 830 may further receive HD map tiles located in a diagonal direction, together with the HD map tiles 1252, 1253, 1254, and 1255 adjacent to the top, bottom, left, and right sides of the first HD map tile 1251. In this case, the processor 830 may receive a total of nine HD map tiles.

As illustrated in FIG. 12B, when there is a preset destination, the processor 830 may receive tiles associated with a path from the location 1250 of the vehicle 100 to the destination. The processor 830 may receive a plurality of tiles to cover the path.

The processor 830 may receive all the tiles covering the path at one time.

Alternatively, the processor 830 may receive just a portion of the tiles at a time while the vehicle 100 travels along the path. For example, the processor 830 may receive only some of the entire tiles based on the location of the vehicle 100 while the vehicle 100 travels along the path. Thereafter, the processor 830 may continuously receive the remaining tiles during the travel of the vehicle 100 and may delete the previously received tiles.

The processor 830 may generate electronic horizon data based on HD map data.

The vehicle 100 may travel in a state where a final destination is set. The final destination may be set based on a user input received via the user interface device 200 or the communication device 400. According to an implementation, the final destination may be set by the driving system 710.

In the state where the final destination is set, the vehicle 100 may be located within a preset distance from a first point during driving. When the vehicle 100 is located within the preset distance from the first point, the processor 830 may generate electronic horizon data having the first point as a start point and a second point as an end point. The first point and the second point may be points on the path heading to the final destination. The first point may be described as a point where the vehicle 100 is located or will be located in the near future. The second point may be described as the horizon described above.

The processor 830 may receive an HD map of an area including a section from the first point to the second point. For example, the processor 830 may request an HD map for an area within a predetermined radial distance from the section between the first point and the second point, and receive the requested HD map.

The processor 830 may generate electronic horizon data for the area including the section from the first point to the second point, based on the HD map. The processor 830 may generate horizon map data for the area including the section from the first point to the second point. The processor 830 may generate horizon path data for the area including the section from the first point to the second point. The processor 830 may generate a main path for the area including the section from the first point to the second point. The processor 830 may generate data of a sub path for the area including the section from the first point to the second point.

When the vehicle 100 is located within a preset distance from the second point, the processor 830 may generate electronic horizon data having the second point as a start point and a third point as an end point. The second point and the third point may be points on the path heading to the final destination. The second point may be described as a point where the vehicle 100 is located or will be located in the near future. The third point may be described as the horizon described above. In some cases, the electronic horizon data having the second point as the start point and the third point as the end point may be geographically connected to the electronic horizon data having the first point as the start point and the second point as the end point.

The operation of generating the electronic horizon data using the second point as the start point and the third point as the end point may be performed by correspondingly applying the operation of generating the electronic horizon data having the first point as the start point and the second point as the end point.

According to an implementation, the vehicle 100 may travel even when the final destination is not set.

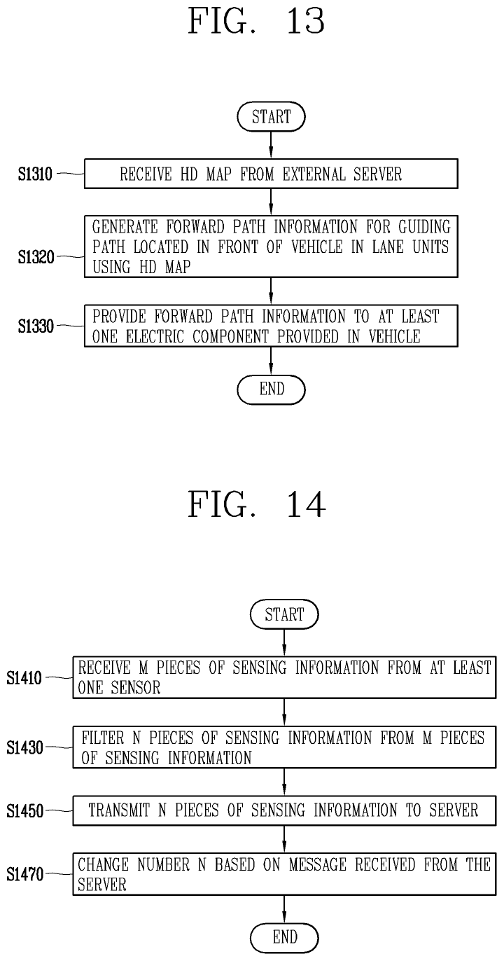

FIG. 13 is a flowchart illustrating a path providing method of the path providing device of FIG. 9.

The processor 830 receives a high-definition (HD) map from an external server (S1310).

The external server is a device capable of performing communication through the first communication module 812 and is an example of the telematics communication device 910. The HD map is ADAS MAP and may include at least one of the four layers described above with reference to FIG. 11B.

The processor 830 may generate forward path information for guiding a road located ahead of the vehicle in lane units using the HD map (S1320).

The processor 830 may generate different forward path information depending on whether a destination is set in the vehicle 100.

For example, when a destination is set in the vehicle 100, the processor 830 may generate forward path information for guiding a driving path (travel path) to the destination in the lane units.

As another example, when a destination is not set in the vehicle 100, the processor 830 may calculate a main path (Most Preferred Path (MPP)) on which the vehicle 100 is most likely to travel, and generate forward path information for guiding the main path (MPP) in the lane units. In this case, the forward path information may further include sub path information related to a sub path, which is branched from the main path (MPP) and on which the vehicle 100 is likely to travel with a higher probability than a predetermined reference.

The forward path information may provide a driving path up to a destination for each lane drawn on the road, thereby providing more precise and detailed path information. The forward path information may be path information that complies with the standard of ADASIS v3.

The forward path information may be provided by subdividing a path, on which the vehicle should travel or can travel, into lane units. The forward path information may be information for guiding a driving path to a destination on the lane basis. When the forward path information is displayed on a display mounted on the vehicle 100, a guide line for guiding a lane on which the vehicle 100 can travel may be displayed on the map. In addition, a graphic object indicating the location of the vehicle 100 may be included on at least one lane in which the vehicle 100 is located among a plurality of lanes included in the map.

The processor 830 may provide the forward path information to at least one electric component provided in the vehicle through the interface unit 820 (S1330). In addition, the processor 830 may also provide the forward path information to various applications installed in the systems of the vehicle 100.

The electric component refers to any device mounted on the vehicle 100 and capable of performing communication, and may include the components 120 to 700 described above with reference to FIG. 7. For example, the object detecting apparatus 300 such as a radar or a LiDAR, the navigation system 770, the vehicle driving apparatus 600, and the like may be included in the electric components.

The electric component may perform its own function based on the forward path information.

The forward path information may include a path in lane units and the location of the vehicle 100, and may include dynamic information including at least one object to be sensed by the electric component. The electric component may reallocate resources to sense an object corresponding to the dynamic information, determine whether the dynamic information matches sensing information sensed by the electric component itself, or change a setting value for generating sensing information.

Next, the processor 830 may receive external information generated by an external device from the external device which is located within a predetermined range with respect to the vehicle (S1340).

The predetermined range refers to a distance at which the second communication module 814 can perform communication, and may vary according to performance of the second communication module 814. When the second communication module 814 performs V2X communication, a V2X communication-available range may be defined as the predetermined range.

Furthermore, the predetermined range may vary according to an absolute speed of the vehicle 100 and/or a relative speed with the external device.

The processor 830 may determine the predetermined range based on the absolute speed of the vehicle 100 and/or the relative speed with the external device, and permit the communication with external devices located within the determined predetermined range.

Specifically, based on the absolute speed of the vehicle 100 and/or the relative speed with the external device, external devices that can perform communication through the second communication module 814 may be classified into a first group or a second group. External information received from external devices included in the first group is used to generate dynamic information, which will be described below, but external information received from external devices included in the second group is not used to generate the dynamic information. Even when external information is received from the external devices included in the second group, the processor 830 ignores the external information.

The processor 830 may generate dynamic information related to an object to be sensed by at least one electric component provided in the vehicle based on the external information (S1350), and match the dynamic information to the forward path information (S1360).

For example, the dynamic information may correspond to the fourth layer described above with reference to FIGS. 11A and 11B.

As described above with reference to FIGS. 11A and 11B, the path providing device 800 may receive the ADAS MAP and/or the LDM data. Specifically, the path providing device 800 may receive the ADAS MAP from the telematics communication device 910 through the first communication module 812, and the LDM data from the V2X communication device 930 through the second communication unit 814.

The ADAS MAP and the LDM data may be provided with a plurality of layers having the same format. The processor 830 may select at least one layer from the ADAS MAP, select at least one layer from the LDM data, and generate the forward path information including the selected layers.

For example, after selecting the first to third layers of the ADAS MAP and selecting the fourth layer of the LDM data, one forward path information may be generated by matching those four layers into one. In this case, the processor 830 may transmit a refusal message for refusing the transmission of the fourth layer to the telematics communication device 910. This is because receiving partial information excluding the fourth layer uses less resources of the first communication module 812 than receiving all information including the fourth layer. By matching part of the ADAS MAP with part of the LDM data, complementary information can be utilized.

For another example, after selecting the first to fourth layers of the ADAS MAP and selecting the fourth layer of the LDM data, one forward path information may be generated by matching those five layers into one. In this case, priority may be given to the fourth layer of the LDM data. If the fourth layer of the ADMS MAP includes information which does not match the fourth layer of the LDM data, the processor 830 may delete the mismatched information or correct the mismatched information based on the LDM data.

The dynamic information may be object information for guiding a predetermined object. For example, the dynamic information may include at least one of position coordinates for guiding the position of the predetermined object, and information guiding the shape, size, and kind of the predetermined object.

The predetermined object may refer to an object that disturbs driving in a corresponding lane among objects that can be driven on a road.

For example, the predetermined object may include a bus stopped at a bus stop, a taxi stopped at a taxi stand or a truck from which articles are being put down.

As another example, the predetermined object may include a garbage truck that travels at a predetermined speed or slower or a large-sized vehicle (e.g., a truck or a container truck, etc.) that is determined to obstruct a driver's vision.

As another example, the predetermined object may include an object informing of an accident, road damage or construction.

As described above, the predetermined object may include all kinds of objects blocking a lane so that driving of the vehicle 100 is impossible or interrupted. The predetermined object may correspond to an icy road, a pedestrian, another vehicle, a construction sign, a traffic signal such as a traffic light, or the like that the vehicle 100 should avoid, and may be received by the path providing device 800 as the external information.

The processor 830 may determine whether or not the predetermined object guided by the external information is located within a reference range based on the travel path of the vehicle 100.

Whether or not the predetermined object is located within the reference range may vary depending on a lane in which the vehicle 100 is traveling and the position of the predetermined object.

For example, external information for guiding a sign indicating the construction on a third lane 1 km ahead of the vehicle while the vehicle is traveling in a first lane may be received. If the reference range is set to 1 m based on the vehicle 100, the sign is located outside the reference range. This is because the third lane is located outside the reference range of 1 m based on the vehicle 100 if the vehicle 100 is continuously traveling in the first lane. On the other hand, if the reference range is set to 10 m based on the vehicle 100, the sign is located within the reference range.

The processor 830 may generate the dynamic information based on the external information when the predetermined object is located within the reference range, but may not generate the dynamic information when the predetermined object is located outside the reference range. That is, the dynamic information may be generated only when the predetermined object guided by the external information is located on the driving path of the vehicle 100 or is within a reference range that may affect the driving path of the vehicle 100.

The path providing device according to the present disclosure may generate the forward path information by integrating information received through the first communication module and information received through the second communication module into one, which may result in generating and providing optimal forward path information capable of complementing different types of information provided through such different communication modules. This is because information received through the first communication module cannot reflect information in real time but such limitation can be complemented by information received through the second communication module.

Furthermore, when there is information received through the second communication module, the processor 830 controls the first communication module so as not to receive information corresponding to the received information, so that the bandwidth of the first communication module can be used less than that used in the related art. That is, the resource usage of the first communication module can be minimized.

FIG. 14 is a flowchart illustrating a method in which a path providing device selectively transmits sensing information generated in a vehicle.

The path providing device 800 may receive an HD map from a server or the like and selectively transmit vehicle driving information generated in the vehicle 100 to the server. The path providing device 800 filters vehicle driving information that the server may be supposed to require or requires and selectively transmit the vehicle driving information. The server corresponds to an example of the telematics communication device 910.

The processor 830 receives m pieces of sensing information from at least one sensor through the interface unit 820 (S1410).

The at least one sensor refers to an electric component provided in the vehicle 100, and the sensing information corresponds to one example of the vehicle driving information.

M is a natural number and denotes the number of sensing information received during a unit time. A plurality of sensing information may be received from the same sensor, or at least one sensing information may be received from different sensors, respectively.

The processor 830 filters n pieces of sensing information from the m pieces of sensing information (S1430), and transmits the n pieces of sensing information to the server (S1450).

Here, the filtering may be defined as extracting or selecting sensing information corresponding to the n pieces among the m pieces of sensing information according to a preset condition. Since n is defined as a natural number smaller than m, the n pieces of sensing information corresponding to the number smaller than m are extracted by the filtering.

When the filtering is performed, the n pieces of sensing information is selected from the m pieces of sensing information. On the other hand, when the filtering is not performed, all the m pieces of sensing information may be selected and transmitted to the server which has provided the HD map. In other words, some pieces of sensing information may be filtered and transmitted to the server.

The processor 830 may change the number n according to various conditions.

For example, the processor 830 may change the number n based on a message received from the server (S1470).

The processor 830 may determine which of the pieces of information received through the interface unit 820 is to be filtered and how many of those pieces of information are to be filtered.

The message received from the server may include an information list for guiding information required by the server. For example, the information list may include a captured image of a predetermined point specified by latitude and longitude, a radar/LiDAR image at the predetermined point, a sensing command for requesting sensing of a predetermined object located at the predetermined point, and the like.

The processor 830 may filter sensing information requested in the information list from among the m pieces of sensing information received through the interface unit 820. The number n varies depending on types of information requested in the information list. In other words, the processor 830 may change the number n based on a message received from the server.

As another example, the processor 830 may change the number n based on the location of the vehicle 100.

If it is assumed that vehicles as many as a natural number t are located in a predetermined area, the number of information generated in the predetermined area corresponds to a value obtained by t x n. An amount of information generated in an area, such as an urban area, in which many vehicles travel, is different from an amount of information generated in an area, such as an open area, where there are few vehicles.

The path providing device 800 may change the number n according to the location of the vehicle 100 so that the total amount of information generated in each area becomes a constant level. For example, in a downtown area, a smaller number of sensing information than in an open area may be filtered and transmitted to the server.

As another example, the processor 830 may change the number n based on the speed of the vehicle 100.

As the vehicle 100 travels faster, the processor 830 receives a larger amount of HD map data from the server, and thereby a usage amount of the processor 830 increases. The processor 830 may change the number n based on the speed of the vehicle 100 so that the usage amount of the processor 830 is constant even if the speed of the vehicle 100 varies. For example, when the speed becomes faster, the number n may be reduced.

Hereinafter, a method of filtering the n pieces of sensing information will be described in more detail.

FIG. 15 is a flowchart illustrating a method in which a path providing device selectively transmits sensing information according to priorities.

The processor 830 may calculate priorities of the m pieces of sensing information, respectively, according to a preset condition (S1510), and filter the n pieces of sensing information based on the priorities (S1530).

The processor 830 may filter sensing information used to specify a current location of the vehicle 100 among the m pieces of sensing information. As a result of the filtering, the n pieces of sensing information may be extracted. The priority may be calculated differently according to a degree that sensing information is used to specify the current location. For example, if first sensing information is used by 100% and second sensing information is used by 80%, the first sensing information has a higher priority than the second sensing information.

Different priorities may be calculated with respect to the sensing information according to sensors generating the sensing information. For example, first sensing information generated by a first sensor may have a higher priority than second sensing information generated by a second sensor.

The preset condition may include a first condition and a second condition. In this case, the processor 830 may calculate the priorities according to any one of the first condition and the second condition based on the location of the vehicle. In other words, the preset condition may vary.

For example, in a straight lane section, a front image captured by a front camera has a higher priority than a side image captured by a side camera, but in a curved lane section, the side image may have a higher priority than the front image.

The processor 830 sequentially transmits the n pieces of sensing information to the server according to the priorities through the communication unit 810 (S1550). Sensing information with a higher priority is transmitted earlier to the server.

The processor 830 may change the preset condition based on a message received from the server (S1570).

The processor 830 may predict a moving path of the vehicle 100 according to the forward path information. The server may also predict the moving path of the vehicle 100 according to the forward path information. When the vehicle 100 moves from a first area requiring a first information list to a second area requiring a second information list, the server transmits a first message requesting the first information list and a second message requesting the second information list to the path providing device 800, respectively.

The processor 830 may perform filtering according to the first information list in the first area, and perform filtering according to the second information list in the second area. As such, the processor 830 can change a criterion for filtering or a criterion for calculating priorities based on the messages received from the server.

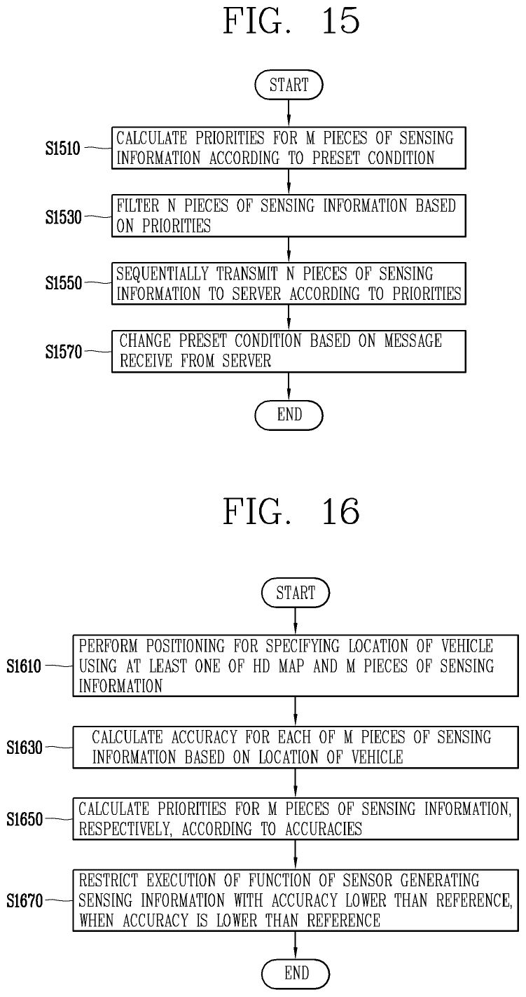

FIG. 16 is a flowchart illustrating a method in which a path providing device calculates accuracy of sensing information based on the position of a vehicle calculated by positioning.

The processor 830 performs positioning for specifying the location of the vehicle using the HD map and at least one of the m pieces of sensing information (S1610).

Positioning refers to specifying the location of the vehicle 100 with coordinate values using reference points such as latitude and longitude. In order to accurately specify the coordinate values of the vehicle 100 on the HD map, sensing information received from the sensors should be used.

For example, the processor 830 may determine in which lane the vehicle 100 traveling on an eight-lane road is located by using a front image obtained by capturing the front of the vehicle 100. In this case, positioning is performed using the front image.

For another example, when the vehicle 100 is moving backward, the processor 830 may perform positioning using a rear image obtained by capturing the rear of the vehicle 100.

The processor 830 may filter, as the n pieces of sensing information, at least one sensing information used for the positioning among the m pieces of sensing information. Specifically, the processor 830 may classify the m pieces of sensing information into a first group used for positioning and a second group not used for positioning, and filter sensing information included in the first group as the n pieces of sensing information.

After the positioning is performed, the processor 830 may calculate accuracy of each of the m pieces of sensing information based on the location of the vehicle 100 (S1630). The accuracies of the m pieces of sensing information are calculated based on the coordinate values calculated as the position of the vehicle 100. For example, accuracy of first sensing information may be calculated by comparing the coordinate values with a first position of the vehicle guided by the first sensing information.

The processor 830 may calculate priorities for the m pieces of sensing information, respectively, according to the accuracies (S1650). The n pieces of sensing information are filtered according to the priorities. For each sensing information, higher priority is given to sensing information with higher accuracy.

When accuracy of sensing information is lower than a reference, the processor 830 may restrict an execution of a function of a sensor that has generated the sensing information with the lower accuracy than the reference (S1670).

The processor 830 generates a message for restricting the execution of the function of the sensor that has generated the sensing information with the lower accuracy than the reference and transmits the message through the interface unit 820. This is to prevent a sensor generating unusable information from generating unnecessary information and occupying the utilization of the processor 830.

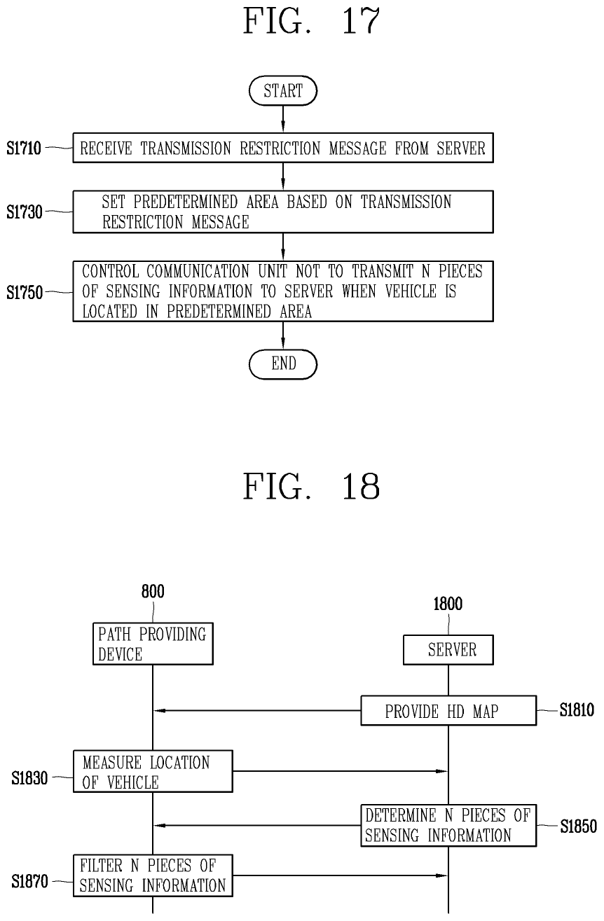

FIG. 17 is a flowchart illustrating a method in which the path providing device does not transmit sensing information to a server based on a transmission restriction message received from the server.

The processor 830 may receive a transmission restriction message from the server (S1710).

The transmission restriction message may be a message for requesting or instructing the path providing device 800 not to transmit the sensing information generated in the vehicle 100 to the server.

The HD map is divided into a plurality of tiles, and each tile includes various objects that serve as references for positioning. For example, signs, traffic lights, cameras, etc. may be fixed at specific positions and may serve as references for positioning the vehicle 100.

The path providing device 800 may transmit sensing information which is obtained by sensing a predetermined object for positioning (or sensing information used for positioning) to the server, and the server may add or update information related to the predetermined object to the HD map by using the sensing information.

The server may classify a plurality of tiles forming the HD map into a first group requiring update and a second group not requiring update.

Whether or not the update is necessary may be determined by an updated date of objects included in each tile. For example, when an updated date of objects included in a first tile satisfies a reference (criterion), the first tile may be classified into a second group. In contrast, when an updated date of at least one of the objects included in the second tile does not satisfy the reference (criterion), the second tile may be classified into a first group. The at least one object that does not satisfy the reference may be added to an information list and transmitted to the path providing device 800 in the form of a message.

When the vehicle 100 is located in or expected to move to at least one tile included in the second group, the server may provide a transmission restriction message for guiding the at least one tile to the path providing device 800 of the vehicle 100.

The processor 830 may set a predetermined area based on the transmission restriction message (S1730). The predetermined area may vary depending on the transmission restriction message.

The predetermined area may correspond to a tile included in the second group. For example, when a first tile is included in the second group, the predetermined area may correspond to the first tile. For another example, when first and second tiles adjacent to each other are included in the second group, the predetermined area may correspond to the first and second tiles.

When the vehicle is located in the predetermined area, the processor 830 controls the communication unit so as not to transmit the n pieces of sensing information to the server (S1750). In the predetermined area where no update is required, the transmission of sensing information sensed by the vehicle to the server is restricted in advance, thereby saving resources of the path providing device 800 and the server.

FIG. 18 is a flowchart illustrating an operation of a communication system including a path providing device and a server.

A server 1800 provides an HD map to the path providing device 800 (S1810).

The path providing device 800 may perform positioning for the location of the vehicle 100 using the HD map (S1830). The location of the vehicle 100 is transmitted to the server 1800.

The path providing device 800 may provide the HD map received from the server to at least one sensor provided in the vehicle, and perform positioning for specifying the location of the vehicle using at least one of sensing information received from the at least one sensor.

The server 1800 may determine n pieces of sensing information based on the location of the vehicle 100, generate an information list for guiding the n pieces of sensing information, and transmit the generated information list to the path providing device 800 (S1850).

The server may change the number n based on the location of the vehicle or based on the speed of the vehicle.

The path providing device 800 may filter the n pieces of sensing information based on the information list received from the server 1800 and transmit the filtered n pieces of sensing information to the server 1800 (S1870).

The server may determine n pieces of sensing information that the vehicle should transmit to the server based on the location of the vehicle, and the path providing device may filter the n pieces of sensing information among m pieces of sensing information received from the at least one sensor, and transmit the n pieces of sensing information to the server.

The processor 830 of the path providing device 800 determines whether or not an object included in the HD map matches object sensing information related to the object sensed by the at least one sensor. If not matched according to the result of the determination, the processor 830 controls the communication unit 810 to transmit the object sensing information to the server. Whether or not wrong information is included in the HD map may be determined by the path providing device 800, and new information may be provided to the server. This may allow the server to maintain timeliness and accuracy of the HD map

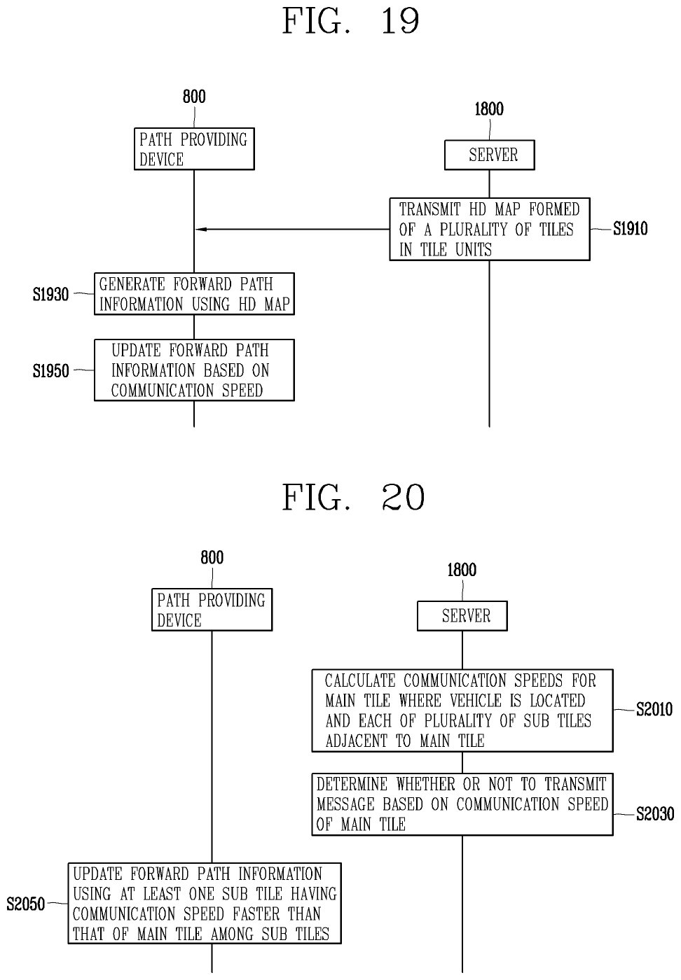

FIG. 19 is a flowchart illustrating an operation of a communication system in accordance with the present disclosure.

The communication system includes a server 1400 and the path providing device 800.

The server 1400 is an example of the telematics communication device 910 described above with reference to FIG. 9.

The server 1400 transmits an HD map formed of a plurality of tiles in tile units (S1910).

For example, the server 1400 may sequentially transmit at least one tile of the plurality of tiles to the path providing device 800 according to a predetermined sequence based on forward path information transmitted from the path providing device 800. Alternatively, the server 1400 may sequentially transmit tiles requested by the path providing device 800 in a requested sequence.

The operation of the path providing device 800 described below may be performed by the processor 830.

The path providing device 800 generates the forward path information using the HD map (S1930).

The forward path information guides a path up to a destination when the destination is set in the vehicle 100, while guiding a path where the vehicle is most likely to travel when the destination is not set. The path where the vehicle is most likely to travel may be the main path (MPP) in FIG. 13.

The forward path information may include at least one layer among the four layers described with reference to FIGS. 11A and 11B.

The forward path information may be transmitted to the server 1800 through the first communication module 812, and may be transmitted to at least one electric component provided in the vehicle 100 through the interface unit 820.

Next, the path providing device 800 may update the forward path information based on a communication speed (S1950). The updated forward path information is transmitted to the server 1400 and the electric component provided in the vehicle 100.

The communication speed may be calculated by at least one of the server 1800 and the path providing device 800. The communication speed may be defined differently depending on which device calculates the communication speed.

For example, the server 1800 may calculate the communication speed, and may share the communication speed with the path providing device 800. The server 1400 may calculate a communication speed of any one tile by using at least one of a data request amount that at least one vehicle (or path providing device) located in the one tile requests to the server 1800 and a data transmission amount that the server 1800 transmits to the at least one vehicle. In this case, the communication speed is calculated differently according to tiles.

As another example, the path providing device 800 may calculate a communication speed with respect to the server 1800 by using a data reception amount received from the server 1800 with respect to a data request amount requested to the server 1800. If the data request amount requested by the path providing device 800 to the server 1800 is x and the data reception amount received from the server 1800 is y for a unit time, the communication speed may be calculated using y/x. Since the data reception amount differs depending on how many path providing devices are located on the tile, the communication speed may be calculated differently according to the tile on which the vehicle 100 is located.

The forward path information is updated according to the communication speed, and the updated forward path information guides a different path and/or a different speed than the existing path and speed. Since the forward path information is updated so that the vehicle 100 moves to a position where the communication speed is higher than a reference, the vehicle 100 may travel in a manner of maintaining a constant communication speed while passengers on board the vehicle 100 are not aware of it.

The timeliness of the HD map is essential for autonomous travel of the vehicle 100, and may be secured only when the communication speed is higher than the reference. Since the path providing device and the communication system update the forward path information so that the communication speed is maintained to be higher than the reference, the safety of the vehicle can be more enhanced. In other words, an accident or error which occurs due to failed reception of necessary information can be prevented in advance.

The path providing device 800 may update the forward path information such that at least one of the path and the speed of the vehicle 100 varies according to the communication speed. For example, the path providing device 800 may update the forward path information such that a road or lane on which the vehicle 100 is scheduled to travel is changed according to the communication speed. As another example, the path providing device 800 may generate a speed adjustment command so that the speed of the vehicle 100 varies according to the communication speed. The speed adjustment command may be included in the forward path information and transmitted to electric components provided in the vehicle 100.

FIG. 20 is a flowchart illustrating in more detail the operation of a communication system in consideration of a communication speed of each tile.

The server 1800 may calculate communication speeds for a main tile where the vehicle 100 is located and each of a plurality of sub tiles adjacent to the main tile (S2010).

When the HD map is formed of tiles in a rectangular shape, as described above with reference to FIG. 12A, there may be one main tile and four sub tiles located adjacent to top, bottom, left, and right sides of the one main tile. Furthermore, four more tiles adjacent to corners of the main tile may also be included in the sub tiles.

This is to search for sub tiles which provide a communication speed of a better environment than the main tile.

The server 1800 may calculate the communication speed of the main tile and determine whether to transmit a message based on the communication speed of the main tile (S2030).

In detail, when the communication speed of the main tile satisfies a preset condition, the message may be transmitted to the path providing device 800. If the preset condition is not satisfied, the message is not transmitted to the path providing device 800.

The server 1800 may restrict the transmission of the message, even if the communication speed satisfies the preset condition, when there is no sub tile having a communication speed faster than the communication speed of the main tile. That is, when not only the main tile but also the sub tiles adjacent to the main tile have communication speeds lower than the reference, the update of the forward path information is a meaningless operation, and thus the message is not transmitted to the path providing device. This is because it is impossible to get a communication speed higher than the reference for allowing the vehicle to move to any sub tile.

The message may include the communication speed of each of the main tile and the sub tiles. In addition, the message may include an update command for instructing the update of the forward path information of the path providing device 800.

The path providing device 800 may update the forward path information in response to the message. In other words, if the message is not received, the path providing device 800 may restrict the update of the forward path information based on the communication speed or may not perform the update of the forward path information.

The path providing device 800 may update the forward path information by using at least one sub tile, which has a communication speed faster than that of the main tile, among the sub tiles (S2050).

For example, when the forward path information includes a path formed from the main tile to a first sub tile but the communication speed of the main tile is lower than the reference, the forward path information may be updated so that the path is changed to a path connected to a second sub tile having a communication speed higher than the reference.

In another example, when the communication speed of the first sub tile is lower than the reference, the forward path information may be updated in a manner of reducing the speed of the vehicle 100, so that the vehicle 100 enters the first sub tile at a time point when the communication speed of the first sub tile is expected to become higher than the reference.

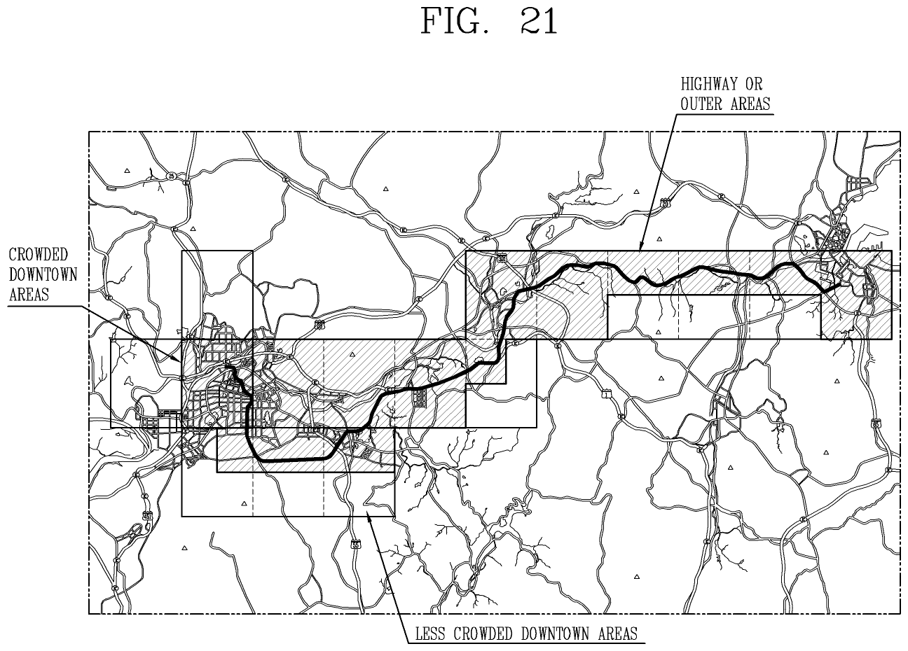

FIG. 21 is a conceptual view illustrating a method of performing different controls by dividing a predetermined tile.

Referring to FIG. 21, different tiles 1610 to 1630 and vehicles 1640 to 1660 located on the respective tiles are shown.

The server 1800 may divide one tile 1610 into a first portion 1610a and a second portion 1610b. More specifically, the tile 1610 may be divided into a first portion 1610a and a second portion 1610b based on the communication speed of the tile 1610, and at least one of size and shape of the first portion 1610a and the second portion 1610b may be defined differently according to the communication speed. In addition, at least one of the size and shape of the first portion 1610a and the second portion 1610b may be defined differently according to the characteristics of a road located on the tile 1610.

For example, as illustrated in FIG. 21, since the tile 1610 has one road extending from lower to upper portions of the tile 1610, the tile 1610 may be divided into a first portion 1610a corresponding to the upper portion and a second portion 1610b corresponding to the lower portion.

This is to properly distribute vehicles receiving the HD map in consideration of the complexity of the tile 1610.

The path providing device provided in each vehicle may update the forward path information to have a different speed depending on which of the first portion and the second portion the vehicle is located in.

For example, a first path providing device of a first vehicle 1640 located in the first portion 1610a may update the forward path information so that the first vehicle travels at a speed faster than a current speed. This is to allow the first vehicle 1640 to quickly leave the tile 1610.

Alternatively, a second path providing device of a second vehicle 1650 located in the second portion 1610b may update the forward path information so that the second vehicle travels at a speed slower than a current speed. This is to allow the second vehicle 1650 to be located longer in the tile 1610.

Even for vehicles located in the same tile, the forward path information of each vehicle is updated differently depending on where the vehicles are located. Accordingly, the complexity of a predetermined area can be appropriately distributed.

On the other hand, the path providing device 800 may determine whether or not the communication speed satisfies a reference.

For example, the path providing device 800 may determine whether the communication speed is higher than or equal to the reference or lower than the reference. When the communication speed is lower than the reference, the path providing device 800 may update the forward path information.

The communication speed may be calculated by the path providing device 800 or mat calculated by the server 1400 and transmitted to the path providing device 800 through the communication unit 810.

The path providing device 800 may request at least some of information, which is to be requested to the server 1400, to an external device located near the vehicle 100.

More specifically, the path providing device 800 may request at least some of the information, which should be requested to the server 1400 or has been requested to the server 1400, to the V2X communication device 930 by using the second communication portion 184 described with reference to FIG. 9.

This is to diversify sources for providing information required by the path providing device. Furthermore, this is to solve communication complexity of the server occurring in the tile where the vehicle 100 is located.

Further, the path providing device 800 may transmit at least part of information received from the server to an external device when the communication speed is lower than the reference.

Vehicles located in a predetermined area receive all information from the server 1400 when the communication speed of the server 1400 satisfies the reference. When the communication speed of the server 1400 does not satisfy the reference, the load of the server 1400 is lowered by sharing information between the vehicles.

In this case, the vehicles may share their forward path information with other vehicles.

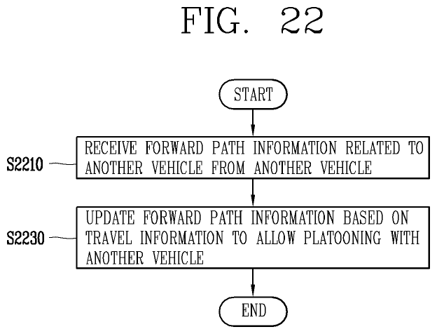

FIG. 22 is a flowchart illustrating an operation of a path providing device performing platooning based on a communication speed.

When the communication speed is lower than the reference, the path providing device 800 may receive forward path information related to another vehicle from the another vehicle (S2210). The forward path information related to the another vehicle may be transmitted in real time, and may include vehicle driving information regarding the another vehicle, such as driving direction, speed, acceleration, whether the brake has been hit, whether the vehicle has been accelerated, and the like.

The path providing device 800 may update the forward path information based on driving information so that platooning with the another vehicle is performed (S2230).

The path providing device 800 may compare its own forward path information with forward path information related to the another vehicle, and perform platooning with the another vehicle by a matched path. In order to perform the platooning, the vehicles included in a platoon may share their own forward path information. Some of the vehicles included in the platoon may stop the reception of the HD map during platooning. As a result, the load of the server 1400 caused in a predetermined area can be reduced.

The present disclosure can be implemented as computer-readable codes (applications or software) in a program-recorded medium. The method of controlling the autonomous vehicle can be realized by a code stored in a memory or the like.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described implementations are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A communication system for a vehicle, comprising:
a server configured to transmit a high-definition map that is divided into a plurality of tiles; and
a path providing device configured to generate forward path information based on the high-definition map, the forward path information being configured, based on a destination being set in the vehicle, to guide the vehicle along a path on which the vehicle is most likely to travel up to the destination,
wherein the path providing device is configured to update the forward path information according to a communication speed between the server and the path providing device at a corresponding one of the plurality of tiles where the vehicle is located.

2. The system of claim 1, wherein the path providing device is configured to update the forward path information such that at least one of the path or a speed of the vehicle is varied according to the communication speed.

3. The system of claim 2, wherein the server is configured to calculate the communication speed and transmit a message to the path providing device based on the communication speed satisfying a preset condition, and
wherein the path providing device is configured to update the forward path information based on the message.

4. The system of claim 3, wherein the server is configured to calculate a communication speed for a main tile where the vehicle is located and for each of a plurality of sub tiles that are adjacent to the main tile, and
wherein the path providing device is configured to update the forward path information based on at least one sub tile among the plurality of sub tiles that has a communication speed higher than that of the main tile.

5. The system of claim 4, wherein the server is configured to restrict a transmission of the message based on none of the plurality of sub tiles having a communication speed that is faster than that of the main tile.

6. The system of claim 3, wherein the server is configured to calculate a communication speed of any one of the plurality of tiles by using at least one of a data request amount requested by at least one vehicle located in the any one tile or a data transmission amount transmitted to the at least one vehicle.

7. The system of claim 2, wherein the server is configured to divide the tile corresponding to a location of the vehicle into a first portion and a second portion, and
wherein the path providing device is configured to update the forward path information to have a first speed based on the vehicle being located in the first portion and a second speed different from the first speed based on the vehicle being located in the second portion.

8. The system of claim 2, wherein the path providing device is configured to calculate the communication speed by comparing a data reception amount from the server to a data request amount to the server.

9. The system of claim 1, wherein the path providing device is configured to request map information from an external device located near the vehicle based on the communication speed being less than a reference value.

10. The system of claim 9, wherein the path providing device is configured to transmit at least part of information received from the server to the external device.

11. The system of claim 10, wherein the path providing device is configured, based on the external device being an additional vehicle and driving information being received from the additional vehicle, to update the forward path information based on the driving information to perform platooning with the additional vehicle.

12. The system of claim 10, wherein the path providing device is configured to transmit the forward path information to the external device.

13. A path providing device for providing path information to a vehicle, the path providing device comprising:
a communication unit configured to receive from a server a high-definition map that is divided into a plurality of tiles; and
a processor configured to generate forward path information based on the high-definition map, the forward path information being configured, based on a destination being set in the vehicle, to guide the vehicle along a path on which the vehicle is most likely to travel up to the destination,
wherein the processor is configured to calculate a communication speed of the server by comparing a data reception amount received from the server to a data request amount requested to the server, and to update the forward path information based on the communication speed.

14. The device of claim 13, wherein the processor is configured to generate a speed adjustment command to thereby vary a speed of the vehicle based on the communication speed being less than a reference value.

15. The device of claim 14, wherein the tile corresponding to a location of the vehicle is divided into a first portion and a second portion, and
wherein the processor is configured to generate the speed adjustment command such that the vehicle has a first speed in the first portion and a second speed different from the first speed in the second portion.

16. The device of claim 13, wherein the processor is configured to request at least part of information, which is to be requested to the server, to an external device located near the vehicle based on the communication speed being less than a reference value.

17. The device of claim 16, wherein the processor is configured to control the communication unit to transmit at least part of information received from the server to the external device.

18. The device of claim 16, wherein the processor is configured, based on the external device being an additional vehicle and driving information being received from the additional vehicle, to update the forward path information based on the driving information to perform platooning with the additional vehicle.

19. The device of claim 16, wherein the processor is configured to control the communication unit to transmit the forward path information to the external device.

20. The device of claim 13, wherein a communication speed is calculated for a main tile where the vehicle is located and for each of a plurality of sub tiles that are adjacent to the main tile, and
wherein the processor is configured to update the forward path information based on at least one sub tile among the plurality of sub tiles that has a communication speed higher than that of the main tile.
